(19) United States
(12) Patent Application Publication
(10) Pub. No.: US 2026/0367664 A1
(43) Pub. Date: Nov. 19, 2026

(54) OPTICAL VECTOR MATRIX MULTIPLICATION SYSTEMS WITH HIGH-PRECISION BIT ENCODING

(71) Applicant: Neurophos Inc., Austin, TX (US)

(72) Inventors: Andrew J. Traverso, Durham, NC (US); Nuno Vasco Dantas da Silva, Caldeira (PT)

(73) Assignee: Neurophos Inc., Austin, TX (US)

(21) Appl. No.: 19/667,615

(22) Filed: May 4, 2026

Related U.S. Application Data
(60) Provisional application No. 63/800,254, filed on May 5, 2025.

(51) Int. Cl. G06E 3/00

(52) U.S. Cl. CPC G06E 3/008

(57) ABSTRACT

The techniques described herein relate generally to optical vector-matrix multiplication (OVMM) systems with high-precision bit encoding. An example system segments each input vector element of an input vector into amplitude-phase encoded segments. The system encodes a weight matrix into a spatial light modulator (SLM), the SLM comprising a plurality of programmable pixels. A transmitter subsystem encodes the amplitude-phase encoded segments into encoded optical signals and transmits the encoded optical signals to the SLM. The SLM modulates the encoded optical signals in accordance with matrix entries of the weight matrix to generate modulated optical signals. A receiving subsystem collects the modulated optical signals to generate a summation output. The summation output represents a partial product of the vector-matrix multiplication (VMM). The system generates output vector values by extracting them from the summation output.

### RELATED APPLICATIONS

This patent claims priority under 35 U.S.C. § 119 (e) to U.S. Provisional Application No. 63/800,254, titled “OPTICAL VECTOR MATRIX MULTIPLICATION SYSTEMS WITH HIGH-PRECISION BIT ENCODING,” filed May 5, 2025, which is hereby incorporated by reference in its entirety.

### FIELD

The techniques described herein relate generally to optical computing and, more particularly, to optical vector-matrix multiplication systems with high-precision bit encoding.

### BACKGROUND

Optical computing and photonics use light instead of electricity to process information, offering substantial improvements in speed and energy efficiency. Photonic integrated circuits include optical components onto a single chip, allowing data to be processed at the speed of light with minimal heat. Such technology is advantageous for heavy mathematical workloads, such as those computed by machine learning models (e.g., neural networks), as such photonic integrated circuits can perform complex matrix multiplications simultaneously across multiple wavelengths.

### SUMMARY

In accordance with the disclosed subject matter, systems, methods, apparatus, and articles of manufacture are provided for optical vector-matrix multiplication systems with high-precision bit encoding.

Some embodiments relate to a system for performing an optical vector-matrix multiplication (OVMM). The system includes a control circuit configured to segment each input vector element of an input vector into amplitude-phase encoded segments. The system is configured to encode a weight matrix into a spatial light modulator (SLM). The SLM includes a plurality of programmable pixels. Each pixel of the plurality of programmable pixels corresponds to a weight matrix element. The weight matrix element includes a most significant bit (MSB) and a least significant bit (LSB). Each pixel of the plurality of programmable pixels is configured in accordance with a complex reflection coefficient. The system includes a transmitter subsystem. The transmitter subsystem is configured to encode the amplitude-phase encoded segments into encoded optical signals. The transmitter subsystem is configured to transmit the encoded optical signals to the SLM. The system includes the SLM, wherein the SLM is configured to modulate the encoded optical signals in accordance with matrix entries of the weight matrix to generate modulated optical signals. The modulated optical signals include a plurality of optical signals that is output from the pixels. The system includes a receiving subsystem to collect the modulated optical signals to generate a summation output, wherein the summation output represents a partial product of the vector-matrix multiplication (VMM). The control circuit is further configured to generate output vector values by extracting them from the summation output.

Some embodiments relate to a method of performing an optical vector-matrix multiplication (OVMM) in an optical computing system. The method includes encoding, by using a controller, a weight matrix into a spatial light modulator (SLM). The SLM includes a plurality of programmable pixels. Each pixel of the plurality of programmable pixels corresponds to a weight matrix element. The weight matrix element includes a most significant bit (MSB) and a least significant bit (LSB). Each pixel of the plurality of programmable pixels is configured in accordance with a complex reflection coefficient. The method includes subdividing, by using the controller, each input vector element of an input vector into amplitude-phase encoded segments. The method includes encoding, by using a transmitter array, the amplitude-phase encoded segments into encoded optical signals. The method includes projecting, by using the transmitter array and a first free space optical path, the encoded optical signals onto the SLM. The method includes modulating, by using the SLM, the encoded optical signals at the plurality of pixels of the SLM according to corresponding matrix entries of the weight matrix to generate modulated optical signals. The method includes imaging, by using a second free space optical path, the modulated optical signals onto a receiver array to generate a summation output. The method includes detecting, by using the receiver array, the summation output. The method includes generating output vector values by extracting them from the summation output.

Some embodiments relate to an optical computing apparatus. The optical computing apparatus includes a photonic integrated circuit including a plurality of waveguides and modulators configured to encode an input vector. The photonic integrated circuit is configured to encode a weight matrix into a spatial light modulator (SLM). The SLM includes a plurality of pixels. Each pixel of the plurality of pixels corresponds to a weight matrix element. The weight matrix element includes a most significant bit (MSB) and a least significant bit (LSB). Each pixel of the plurality of pixels is configured in accordance with a complex reflection coefficient. The photonic integrated circuit is configured to segment each input vector element of an input vector into amplitude-phase encoded segments. The photonic integrated circuit is configured to encode the amplitude-phase encoded segments into encoded optical signals. The photonic integrated circuit is configured to project the encoded optical signals onto the SLM the SLM configured to modulate the encoded optical signals at the plurality of pixels of the SLM according to corresponding matrix entries of the weight matrix to generate modulated optical signals. The optical computing apparatus includes free space optics configured to perform a summation of modulated optical signals to generate a summation output. The optical computing apparatus includes a receiver array including a plurality of optical detectors configured to detect the summation output. The optical computing apparatus includes an electronic integrated circuit. The electronic integrated circuit is configured to drive the modulators on the photonic integrated circuit and to decode output values from the receiver array. The electronic integrated circuit is configured to generate output vector values by extracting them from the summation output.

### BRIEF DESCRIPTION OF DRAWINGS

Various aspects and embodiments of the present technology will be described with reference to the following figures. It should be appreciated that the figures are not necessarily drawn to scale. Items appearing in multiple figures are indicated by the same or a similar reference number in all the figures in which they appear.

FIG. 1A illustrates a block diagram of an operational flow and some components of an example optical vector-matrix multiplication (OVMM) system, in accordance with some embodiments of the technology described herein.

FIG. 1B illustrates an example OVMM device configured to implement the OVMM system of FIG. 1A, in accordance with some embodiments of the technology described herein.

FIG. 1C illustrates a block diagram of an example OVMM device configured to implement the OVMM system of FIG. 1A and/or the OVMM device of FIG. 1B, in accordance with some embodiments of the technology described herein.

FIG. 2 illustrates an 8-bit integer constellation diagram for a metasurface, in accordance with some embodiments of the technology described herein.

FIG. 3 illustrates an example of a binary partitioning of an integer into multiple 2-bit values, in accordance with some embodiments of the technology described herein.

FIGS. 4A and 4B illustrate tables of example segmented values relating to the operational flow of one static metasurface representation with an iterative input vector, in accordance with some embodiments of the technology described herein.

FIG. 5 illustrates a table of example metasurface states, coefficient values, and vector iteration counts, in accordance with some embodiments of the technology described herein.

FIG. 6 illustrates a table of the defined range for an extended Institute of Electrical and Electronics Engineers (IEEE) 5-bit floating-point (FP5) with 2 exponent bits and 2 mantissa bits (E2M2), in accordance with some embodiments of the technology described herein.

FIG. 7 illustrates an example of an example FP5 (E2M2) constellation diagram for a metasurface, in accordance with some embodiments of the technology described herein.

FIG. 8A illustrates a table of example FP5 (E2M2) values mod(FP5, 2) values, in accordance with some embodiments of the technology described herein.

FIG. 8B illustrates an example of a mod(FP5, 2) constellation diagram for a metasurface, in accordance with some embodiments of the technology described herein.

FIG. 9 illustrates an example constellation diagram for FP5 (E2M2) with the range split between two axes, in accordance with some embodiments of the technology described herein.

FIG. 10A is a diagram illustrating a modulus value, K, used to establish a split between the most significant bits (MSB) and the least significant bits (LSB), in accordance with some embodiments of the technology described herein.

FIG. 10B illustrates a table showing an example conversion from the FP5 (E2M2) to a sparse integer range, in accordance with some embodiments of the technology described herein.

FIG. 10C illustrates an example constellation diagram for FP5 (E2M2) with mod(2) projected onto the metasurface, in accordance with some embodiments of the technology described herein.

FIG. 11A illustrates a table showing how a signed value can be encoded, offset, and split for use in the described optical system, in accordance with some embodiments of the technology described herein.

FIG. 11B illustrates a table showing the associated 2-bit values for the vector element

$${V}_{i}^{lin} = - 6$$

after the modified transmitted iterations when a phase shift is available on the silicon photonic device, in accordance with some embodiments of the technology described herein.

FIG. 12 is a table illustrating floating-point values in the FP5 (E2M2) format scaled by various powers of two, in accordance with some embodiments of the technology described herein.

FIG. 13 is a schematic illustrating a floating-point matrix element decomposed into segments, in accordance with some embodiments of the technology described herein.

FIG. 14 illustrates a table of example numbers of metasurface cycles used to attain various levels of floating-point precision with respect to the linear precision on the metasurface, in accordance with some embodiments of the technology described herein.

FIG. 15A is a metasurface cell which may be included in the SLM of the OVMM device of FIG. 1B and/or the metasurface of the OVMM system of FIG. 1C, in accordance with some embodiments of the technology described herein.

FIG. 15B is a graph showing liquidus/solidus lines (estimated Tₘᵢₓ) corresponding to Xₐ (solid line) and X_{b} (dashed line), according to some embodiments described herein. The Eutectic point is shown as the intersection (circle), in accordance with some embodiments of the technology described herein.

FIG. 16 shows various molecular structures of liquid crystal mesogens that may be used to formulate high-birefringence liquid crystal mixtures, in accordance with some embodiments of the technology described herein.

FIG. 17 is a flowchart representative of an example process that may be performed and/or implemented using (i) hardware logic or (ii) machine-readable instructions that may be executed by processor circuitry to implement the OVMM system of FIG. 1A, the OVMM device of FIG. 1B, and/or the OVMM device of FIG. 1C, in accordance with some embodiments of the technology described herein.

FIG. 18 is an example electronic platform including the OVMM system of FIG. 1A, the OVMM device of FIG. 1B, and/or the OVMM device of FIG. 1C and structured to effectuate the process of FIG. 17, in accordance with some embodiments of the technology described herein.

### DETAILED DESCRIPTION OF INVENTION

The present disclosure provides techniques for achieving improvements in the technology of computing general linear operations by using optical signaling. The techniques involve modulating coherent, incoherent, or partially coherent light to generate a plurality of samples of a signal to which a linear operation is to be applied. The samples of signal may be encoded using any number of methods described herein to improve computation precision and/or latency. Spatial light modulator elements can be configured to alter an amplitude and/or a phase of the signal samples. The signals after being modulated can be recombined with the sample fields either coherently superimposed or incoherently summed to determine the result of the computed linear operation. The signals can be recombined using free space optics.

Vector-matrix multiplication (VMM) (also referred to as matrix-vector multiplication) is a fundamental operation in artificial neural networks and other computational systems. The inventors have recognized in the context of the present disclosure that optical implementations of VMM offer the potential for high-throughput, low-latency computation by exploiting the inherent parallelism of free space optical signal propagation. For example, optical vector-matrix multiplication (OVMM) may be performed by using optical devices that perform VMM using encoded optical signals.

The inventors have recognized within the context of this disclosure that conventional OVMM devices often suffer from latency associated with loading input data onto spatial light modulators (SLMs) (e.g., programmable metasurfaces) or other programmable optical encoding elements. For example, a silicon photonics platform may provide high-speed transmission of an input vector and read the resulting product at rates exceeding 10 Gigahertz (GHz), while a weight matrix is represented via a programmable metasurface operating on the order of 1 Megahertz (MHz). This mismatch in operating speeds between the metasurface and the silicon photonics platform introduces a technological challenge in achieving high-precision computation without incurring undue latency from iterative switching. Furthermore, in implementations where multiple sequential matrix operations are required, the output of each stage must be re-encoded onto an optical modulator to serve as the input to the subsequent stage, introducing additional round-trip latency at each computational layer. The inventors have appreciated in the context of the present disclosure that it is advantageous in some embodiments to increase the precision of the SLM such that a minimal number of native clock cycles is required to achieve a desired precision. Unless otherwise specified, a “native” clock cycle refers to one switching event of the SLM (e.g., metasurface).

Although high-precision encoding is desirable for the SLM, other factors may constrain precision in a free space optical system. For instance, manufacturing variances in conventional optical elements, such as lens curvature, surface flatness, and roughness can affect overall precision of the optical system. One measure commonly used to assess optical quality is the Strehl ratio, which compares the measured point spread function (PSF) of an actual optical system to that of an ideal system. A Strehl ratio of 1 indicates a perfect system. The Strehl Ratio can be approximated in terms of the phase variance as follows:

S≈e^{-(2πσ)}^{²}

σ²=((φ−φ̅)²)

In the approximation above, σ is the root mean squared (RMS) wavefront error in units of a wavelength of a field coupled to the optical system and φ is a corresponding phase in similar units. For context, an optical system is considered diffraction-limited if S≥0.8 which for a value of 0.8 only corresponds to a wavefront error of

$$∼ \frac{λ}{14} .$$

The inventors nave recognized within the context of the present disclosure that precision-designed optical systems with very tight tolerances can push the error to as low as

$$\frac{λ}{30} or even \frac{λ}{50} ,$$

but this is very close to the limit for an achievable real-world system. Accordingly, the upper limit in achievable bit precision in phase is approximately 5-bit

$$( \frac{λ}{32} ) .$$

Phase-encoded OVMM architectures, in which the matrix weights or input vector elements are encoded as phase values imparted to the optical field by a phase modulator or SLM, may also suffer from encoding precision. In such systems, the precision of the OVMM is directly limited by the precision with which optical phase can be set and maintained by the modulation hardware. Phase modulators are subject to nonlinearities, quantization errors arising from finite phase resolution, thermal drift, and fabrication-induced variation, all of which introduce errors into the encoded phase values that propagate through the optical system and corrupt the computed output.

The inventors have appreciated in the context of the present disclosure that precision limitations are introduced by encoding data in phase alone. In some embodiments, the optical information may be encoded via a quadrature amplitude modulation (QAM)-style encoding, wherein both amplitude and phase information of the optical signal is encoded. By exploiting both the amplitude and phase degrees of freedom of the optical field to encode numerical information, rather than relying exclusively on either amplitude or phase encoding alone, the techniques described herein overcome the latency, bit precision, and encoding fidelity limitations common in conventional OVMM architectures.

Increasing the precision beyond QAM-256, which provides a good benchmark of 4-bit integers in the real domain and 4-bit integers in the imaginary domain for the achievable precision in phase and amplitude, respectively, would incur a higher bit error rate or require a dramatically higher optical power. While this approach achieves an encoding up to 8-bits on the metasurface for each cycle time (split between amplitude and phase), the approach may be different for a photonics transceiver operating at rates above 10 GHz.

The driving constraint for the transceiver arises from the mathematical operation, vector matrix multiplication, which comes down to a pointwise multiplication followed by a row summation. For a given N×N matrix with precision B_{M} and an input vector of length N and precision B_{V}, the maximal precision needed to capture the full precision, B_{R}, of a given element in the output vector product is:

B_{R}=B_{M}+B_{V}+ceil(log₂(N))

The term ceil (x) is the operand that rounds up a value x to the closest integer. Thus, for a precision-faithful measurement of the output values, the receiver may carry a precision equivalent to the sum of the input precisions, and scales with the vector dimension. This is a greater precision than either the matrix or vector inputs. To ensure the metasurface can utilize phase modulation to the highest achievable bit precision within the system's tolerance, the silicon photonics transmitter in some embodiments may exclusively employ amplitude modulation. In some such embodiments, the system may use a 180° phase shift to represent negative values. For example, the system may utilize pulse-amplitude modulation (PAM) encoding information (e.g., input vectors and/or matrices).

In some embodiments, the receiver measures the product of the matrix multiplication. The receiver may be configured to measure the full complex waveform of the modulated light at a high enough precision to accommodate the matrix multiplication product and do so at the same >10 GHz clock-rate of the transmitter. In some embodiments, the receiver may utilize an In-phase & Quadrature (IQ) detection scheme. In some embodiments, the resultant signal from the matrix multiply product is mixed with a reference local oscillator at different relative phase offsets (e.g., 0°, −90°, 90°, 180°) allowing for the in-phase and quadrature amplitudes to be measured, which subsequently provides the real and imaginary components of the signal, which correspond to the phase and amplitude. In some embodiments, the in-phase and quadrature amplitudes are measured simultaneously.

In accordance with the present disclosure, the foregoing technological limitations of both phase-encoded and amplitude-encoded OVMM architectures may be mitigated and/or overcome by encoding matrix weights and/or input vector elements by using a most significant bits (MSBs) and least significant bits (LSBs) schema. In some such embodiments, a full-precision numerical value (e.g., a matrix element or an input vector element) is separated into a hierarchy of binary bit planes that are encoded and processed independently across multiple optical channels. By decomposing each numerical value into constituent bit planes and assigning the MSBs to the optical channels or modulation states with the highest signal-to-noise ratio and the greatest immunity to noise and nonlinearity, the OVMM architecture disclosed herein ensures that the highest-impact numerical information is encoded and recovered with the greatest fidelity. Beneficially, errors introduced by noise, phase imprecision, and/or amplitude nonlinearity are confined to the LSB planes where the effect on the overall computed result is minimized.

This hierarchical encoding approach is analogous to the decision region structure of a QAM constellation, in which the MSBs determine a coarse quadrant location of the transmitted signal while the LSBs resolve the fine position within the quadrant. Consequently, errors at the LSB level produce only small perturbations in the recovered value rather than catastrophic misclassification of the entire symbol. Thus, the present disclosure provides an OVMM architecture that achieves improved numerical precision and robustness relative to conventional single-channel phase or amplitude encoding schemes, while preserving the parallelism and low-latency computation that constitute the primary advantages of optical over electronic processing.

Embodiments disclosed herein relate to an OVMM architecture that computes general linear operations by using optical signaling. These general linear operations may be used to compute a vector-matrix multiplication, for example those used in the implementation of machine learning models and/or, more generally, artificial intelligence models. An example machine learning model is an artificial neural network. Examples of an artificial neural network include a convolutional neural network (CNN), a recurrent neural network (RNN), and long short-term memory (LSTM) networks.

In some embodiments, the OVMM architecture includes a spatial light modulator (SLM). A collection of individual SLM modulators may be grouped, the group denoted as an “SLM frame,” so that the modulation applied by each modulator in the group corresponds to the value of an element in a single row of the matrix to be multiplied. The matrix can be a weight matrix. The element-wise multiplication of the input vector and the single row may be implemented by modulating each transmit mode as relayed to the SLM by the corresponding SLM modulator with the result in the respective scattered modes of the SLM modulators.

The SLM may be implemented by at least one metasurface. In some embodiments, a metasurface includes an engineered two-dimensional material including subwavelength-scale elements (e.g., a two-dimensional array of rows and columns of subwavelength-scale elements). The metasurface may be configured to achieve dynamic wavefront shaping, phase modulation, and/or polarization control through localized electromagnetic responses. In the context of the present disclosure, a “metasurface cell” refers to an individual programmable element within the metasurface matrix that can be selectively tuned to exhibit different optical properties, such as phase shift, reflectance, transmission, or the like. For example, a controller can generate and/or output an applied voltage to dynamically control each metasurface cell. In some embodiments, the voltage applied by the controller to each metasurface cell dictates the metasurface cell's refractive index or other optical property, enabling reconfigurable optical computation. The controller can adjust the voltage applied to each cell to dynamically alter the optical behavior of the metasurface. Beneficially, the metasurface can be tuned and controlled as part of a system used to perform complex computational tasks with high speed and efficiency.

A wide variety of metasurfaces may be utilized with various architectures of metasurface cells. For example, a metasurface cell may include two resonators that are spaced apart from one another by less than a wavelength within an operational bandwidth. The dimensions of the resonators may be selected based on the target response of the metasurface. The metasurface cell may further include a voltage-tunable dielectric material between the resonators. For example, the refractive index, and therefore the phase response, of the metasurface cell may be dynamically adjusted by applying a voltage differential across the voltage-tunable dielectric between the two resonators.

The optical signals generated across multiple iterations are combined or reconstructed electronically to produce a final output vector with a target numerical precision. Because the metasurface cells are driven iteratively across multiple cycles, rather than in a single cycle, the target precision can exceed the natural resolution limit of the metasurface. Beneficially, this technique provides flexibility in handling various data types, including integer or floating point (FP) (or floating-point) representations. Furthermore, systems configured in accordance with the OVMM architecture described herein can accommodate floating-point formats by encoding sign, exponent, and mantissa in phase and amplitude. In some embodiments, such systems can support a modulo-based or threshold-based partitioning to reduce errors and/or extend dynamic range.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

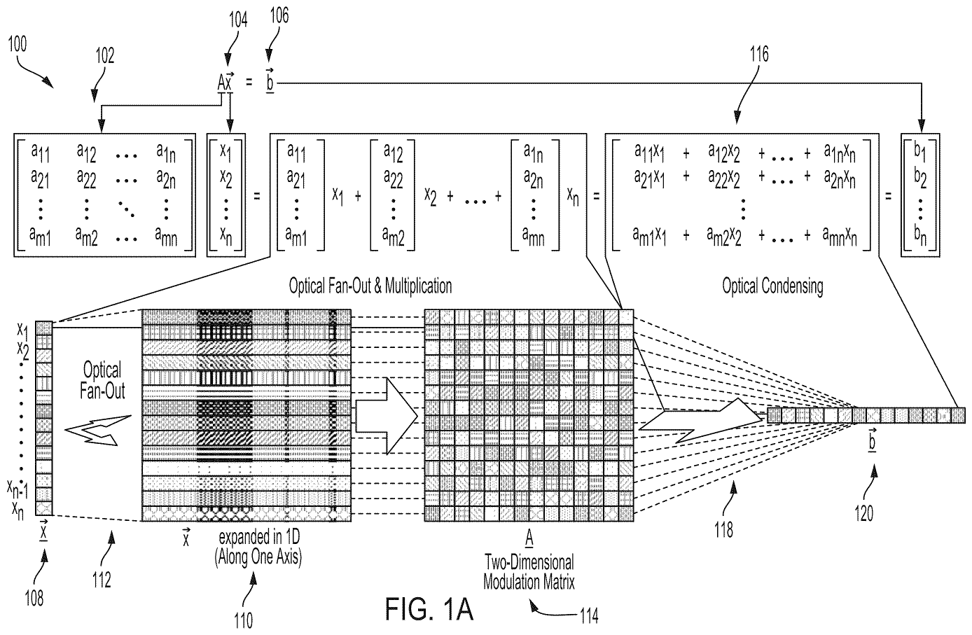

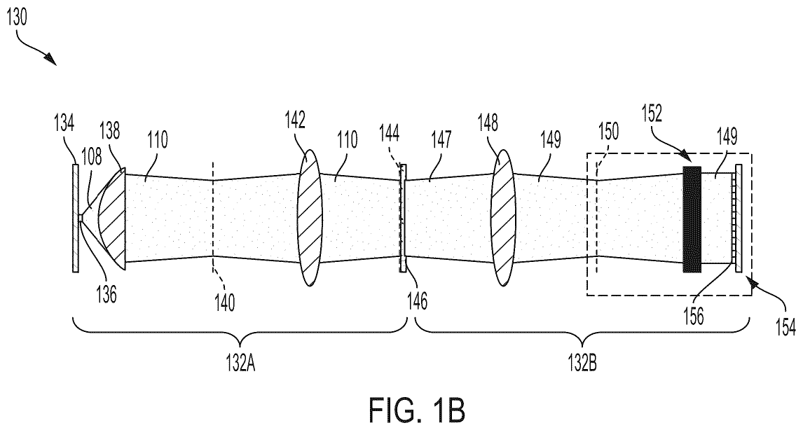

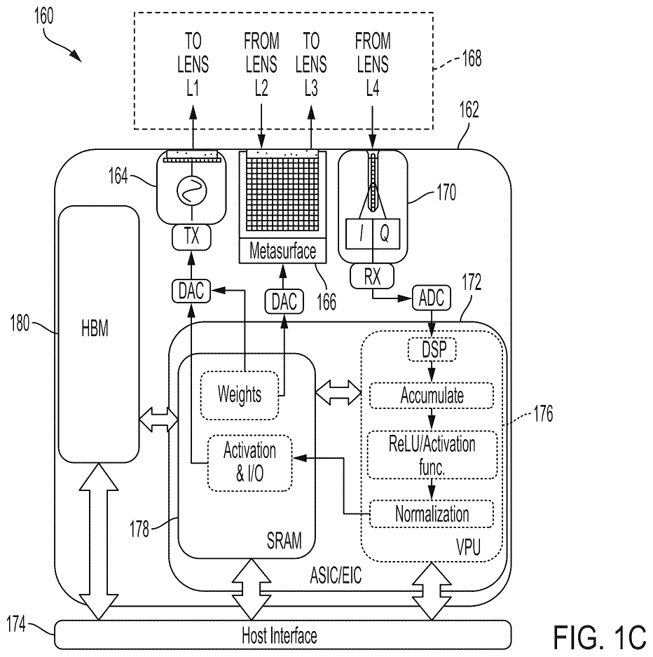

Turning to the figures, FIG. 1A illustrates a block diagram of an operational flow and some components of an example optical vector-matrix multiplication system 100. As described herein, the operations may be implemented via a combination of at least silicon photonic components, a two-dimensionally programmable and/or tunable optical metasurface, and/or a free space optical subsystem.

FIG. 1A illustrates a block diagram of the operational flow and some components of an example optical vector-matrix multiplication system 100. In the illustrated example, the system 100 is computing the mathematical equivalent of A\vec{x}=\vec{b}, where A is a matrix 102 of, for example, weightings to be applied via multiplication to an input vector, \vec{x}, 104. A resultant vector, \vec{b}, 106 is the product of the vector-matrix multiplication. While in FIG. 1A the vector-matrix multiplication is illustrated in a conventional form as rows and columns, embodiments are not limited to implementations that physically arrange the elements in rows and columns as shown.

The input vector 104 is encoded into a vector-encoded optical signal 108 via one or more components. Examples of the components include a digital-to-analog converter, an amplifier, a plurality of waveguides and modulators, and/or one or more optical radiation transmitters of a silicon photonic transmitter subsystem. The vector-encoded optical signal 108 includes amplitude-modulated and/or phase-modulated optical radiation corresponding to the input vector 104.

As shown, the vector-encoded optical signal 108 is expanded into a fanned-out vector-encoded optical signal 110 via an optical fan-out operation 112 performed by the free-space optical subsystem. The optical fan-out operation 112 spreads the vector-encoded optical signal 108 along a first axis (e.g., in one dimension). The fanned-out vector-encoded optical signal 110 represents the data of the original input vector 104 distributed across the dimensions of the metasurface, which can be configured to implement a two-dimensional modulation matrix 114 as shown.

In some embodiments, the two-dimensional modulation matrix 114 includes optical modulation parameters to be applied to incident optical radiation. Examples of the optical modulation parameters include amplitude modulation parameters and phase modulation parameters. The optical modulation parameters can be programmed into the metasurface to correspond to the values (e.g., weightings) of the matrix 102. The optical fan-out operation 112 of this example ensures that each element of the vector-encoded optical signal 108 aligns correctly with the corresponding optical modulation parameter of the two-dimensional modulation matrix 114 applied to the programmable optical metasurface.

The fanned-out vector-encoded optical signal 110 interacts with the optical modulation parameters on the programmable optical metasurface. Again, the optical modulation parameters of the two-dimensional modulation matrix 114 correspond directly to the elements of the matrix 102. As the fanned-out vector-encoded optical signal 110 passes through and/or is reflected by the metasurface, the optical radiation is modulated pixel-by-pixel to produce a modulated optical signal that represents the unsummed results of vector-matrix multiplication 116. Effectively, the metasurface performs the element-wise multiplication of the vector elements with the matrix parameters.

The free space optical subsystem performs a condensing operation 118 on the modulated optical signal. The condensing operation 118 condenses the modulated optical signal along the first axis, effectively summing the contributions of each element to form a condensed optical signal 120. The condensed optical signal 120 corresponds to the final resultant vector, \vec{b}, 106 of the vector-multiplication, A\vec{x}=\vec{b}. Although not illustrated in FIG. 1A, the silicon photonic receiver subsystem can be configured to detect and decode the condensed optical signal 120 into electronic signals for further processing or use.

FIG. 1B illustrates an example optical vector-matrix multiplication (OVMM) device 130. In some embodiments, the OVMM device 130 is configured to perform the VMM described in connection with FIG. 1A. The OVMM device 130 of this example contains a number of optical elements in a first free space optical path 132A and a second free space optical path 132B (collectively free space optical path 132). The OVMM device 130 performs VMM using light (e.g., coherent, incoherent, or partially coherent light) propagated through a series of the optical elements arranged along a common optical axis.

A transmission (TX) array 134 at the beginning of the first free space optical path 132A includes a plurality of TX elements 136 that emit the vector-encoded optical signal 108. Examples of the plurality of TX elements 136 include light-emitting diodes (LEDs) and laser diodes. Each TX element 136 can be configured to encode a component of the input vector 104, with an intensity, amplitude, and/or phase of emitted light representing the corresponding scalar value. TX elements 136 of this example are each driven with analog amplitude corresponding to the input vector 104 values.

Vector-encoded optical signals 108 emitted by the TX elements 136 are collected by a first lens 138. Examples of the first lens 138 include a converging lens and a cylindrical lens. The first lens 138 may be configured to perform the optical fan-out operation 112 and generate the fanned-out encoded optical signal 110. In some embodiments, the first lens 138 may be configured to perform a first Fourier transform of the vector-encoded optical signal 108. The first lens 138 of this example subsequently focuses the fanned-out vector-encoded optical signal 110 on a first image plane 140.

A second lens 142 is positioned downstream of the first lens 138 and configured to collect and collimate light (e.g., the fanned-out vector-encoded optical signal 110) from the first lens 138. Examples of the second lens 142 include a converging lens and a cylindrical lens. The second lens 142 focuses the fanned-out vector-encoded optical signal 110 on a second image plane 144. In some embodiments, the second lens 142 is configured to perform a second Fourier transform on the fanned-out vector-encoded optical signal 110.

As shown, a static light modulator (SLM) 146 is positioned at the second image plane 144. The second lens 142 may be configured to map each TX element 136 to a spatially distinct and well-defined region of the SLM 146, enabling independent row-by-row weighting of the input vector 104 components. For example, the TX array 134 may be configured to project the encoded optical signals onto the SLM via the first lens 138 and/or the second lens 142. Each cell of the SLM 146 can be configured to encode a weight value of the two-dimensional modulation matrix 114. The SLM 146 may modulate the amplitude, intensity, and/or phase of the incident light in proportion to the corresponding matrix element of the two-dimensional modulation matrix 114 to generate an SLM output 147.

The SLM 146 may include a plurality of programmable pixels (e.g., cells) arranged into frames. In some embodiments, each frame of the frames may correspond to a row the two-dimensional modulation matrix 114. The two-dimensional (2D) spatial arrangement of SLM frames may map directly to the rows and columns of the two-dimensional modulation matrix 114, enabling simultaneous parallel weighting of all input channels across the SLM 146 in a single optical pass.

The SLM 146 may be implemented with materials whose reflectivity or transmissivity and/or phase retardation may be controlled, for example by using an electronic signal. In some embodiments, the SLM 146 may be implemented by using a reflective metasurface. In other embodiments, the SLM 146 may be implemented by using a transmissive metasurface.

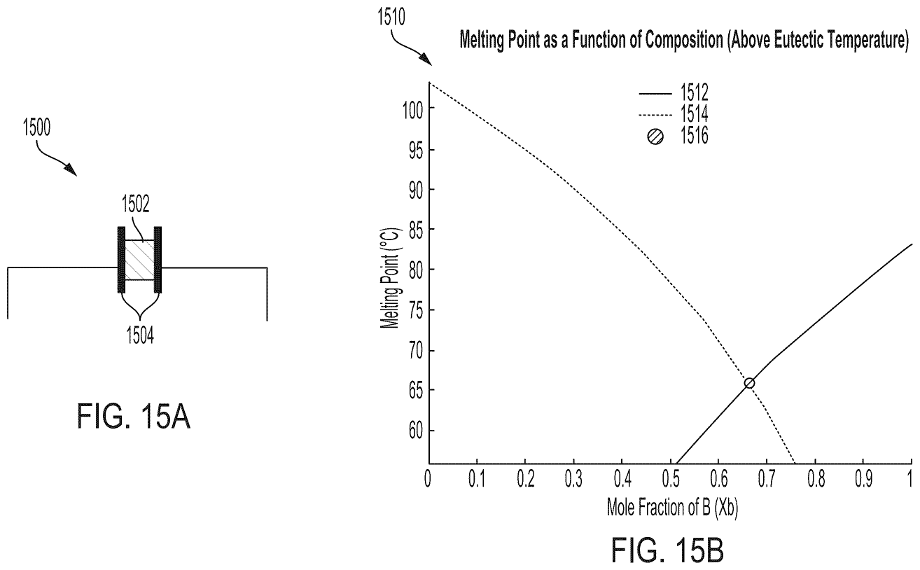

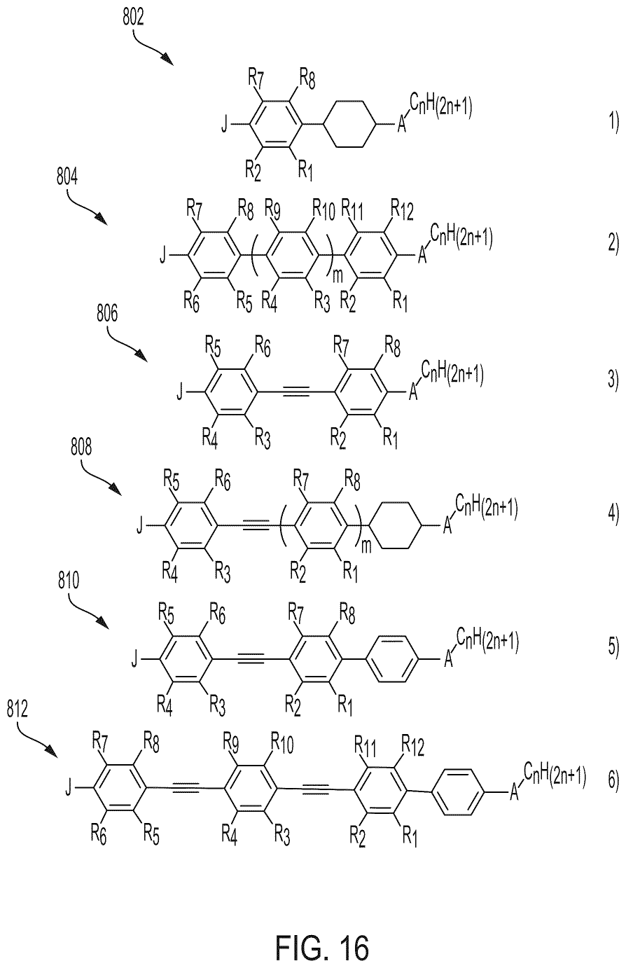

In some embodiments, the SLM 146 may be implemented as an active metasurface (e.g., a programmable metasurface) with liquid crystal, as described further in connection with FIGS. 15B and 16. In other embodiments, the SLM 146 may be implemented with an active metasurface with electrochromic molecules.

In some embodiments, the OVMM device 130 may utilize other types of SLMs. For example, if information is encoded at the TX array 134 using light intensity (e.g., with a coherent, partially coherent, or incoherent light source), an array of electro-absorptive modulators (EAMs) may be utilized instead of a metasurface.

Following the SLM 146 is a third lens 148. Examples of the third lens 148 include a converging lens and a convex lens. The third lens 148 can be configured to collect and re-collimate the modulated beam exiting the SLM 146, relaying the beam toward a third image plane 150. The third lens 148 may be configured to perform the condensing operation 118 as described in connection with FIG. 1A, generating a fanned-in optical signal 149.

In some embodiments, the third lens 148 performs a third Fourier transform on the light exiting the SLM 146, converting the weighted spatial distribution into an angular spectrum. This Fourier transformed light optically integrates the contributions from all TX elements 136 that share a same matrix column.

A fourth lens 152 is disposed downstream of the third image plane 150 and is configured to receive the re-collimated, modulated light. Examples of the fourth lens 152 include a converging lens and a cylindrical lens.

The fourth lens 152 of this example is configured to focus the light to a receiver (RX) array 154, the RX array 154 supporting a plurality of RX elements 156. The fourth lens 152 may be configured to map each TX element 136 onto a spatially distinct location on the RX array 154. The fourth lens 152 may be configured to ensure that each RX element 156 receives light corresponding to exactly one output of the vector-matrix multiplication 116. The resulting signal, detected at each RX element 156, contains the vector-matrix multiplication 116 result after analog values are decoded.

In some embodiments, the TX array 134 includes a first 2D array of grating couplers, each grating coupler optically coupled to one or more corresponding ones of the plurality of optical detectors via optical waveguides on the photonic integrated circuit (PIC) (not shown). In some such embodiments, the RX array 154 includes a second two-dimensional array of grating couplers, each optically coupled to one or more corresponding optical detectors via optical waveguides on the PIC. In some embodiments, adjacent grating couplers are separated by a pitch sufficient to provide optical isolation between channels such that stray light incident on the RX array 154 outside an acceptance cone of a given grating coupler does not couple into the optical waveguide associated with that grating coupler. In some embodiments, the pitch may be in a range of 50 μm to 5 mm.

In some embodiments, the PIC includes a plurality of waveguides and modulators configured to encode the input vector. In some embodiments, a number of the plurality of optical modulators, a number of the plurality of programmable pixels (e.g., of the SLM 146 or the metasurface 166), and a number of a plurality of optical detectors in the RX array 154 are all equal.

In some embodiments, the RX array 154 includes a low-reflectivity absorbing material disposed between adjacent grating couplers. The absorbing material may be configured to attenuate stray optical signals not directed at any grating coupler. For example, the absorbing material may be at least one of a carbon black, graphite, titanium nitride, black chrome, iron oxide, carbon nanotube composite, or photo-absorbing material. In some embodiments, the absorbing material is a metasurface engineered to not reflect (e.g., block or absorb) light within a predefined wavelength range.

In other embodiments, the TX array 134 includes a first two-dimensional array of emitting couplers, each emitting coupler optically coupled to a corresponding waveguide modulator on the PIC. In some such embodiments, the RX array 154 includes a second two-dimensional array of emitting couplers, each optically coupled to one or more corresponding optical detectors via optical waveguides on the PIC.

FIG. 1C illustrates a block diagram of an example implementation of an OVMM system 160, which includes an OVMM device 162. As illustrated, the OVMM system 160 includes a tight integration of various subsystems and components that enable high-speed, energy-efficient computational operations. In some embodiments, the OVMM system 160 implements an optical computing apparatus and/or system at least in part.

The OVMM device 162 includes a silicon photonic transmitter subsystem 164 that operates to encode an input vector (e.g., digital input vector) into a transmitted optical signal. In some embodiments, the silicon photonic transmitter subsystem 164 can be implemented by and/or correspond to the TX array 134 of FIG. 1B. The encoding is achieved using phase modulation and/or amplitude modulation through integrated photonic devices, such as electro-absorption modulators, Mach-Zehnder interferometers, optical ring resonators, silicon-insulator-silicon-capacitive (SISCAP) modulators, or thermal modulators. In some embodiments, the silicon photonic transmitter subsystem 164 includes a plurality of waveguides and modulators to encode the input vector. The silicon photonic transmitter subsystem 164 can be configured to convert the digital input vector into an optical format (e.g., as a vector-encoded optical signal 108) to be received by the two dimensionally programmable and/or tunable optical metasurface 166 via a free space optical subsystem 168. In some embodiments, the optical metasurface 166 can be implemented by and/or correspond to the SLM 146 of FIG. 1B. In some embodiments, the silicon photonic transmitter subsystem 164 is configured to iteratively illuminate the SLM with the vector-encoded optical signal.

The free space optical subsystem 168 receives the vector-encoded optical signal. In some embodiments, the free space optical subsystem 168 operates to distribute the vector-encoded optical signal across the dimensions of the metasurface 166 (e.g., an SLM). In some embodiments, the free space optical subsystem 168 incorporates lenses and/or mirrors to ensure precise alignment and transformation of the vector-encoded optical signal into a fanned-out vector-encoded optical signal.

The vector-encoded optical signal is directed for incidence on the metasurface 166. The metasurface 166 is dynamically tuned to encode a digital matrix as a two-dimensional array of optical modulation parameters. Each pixel on the metasurface 166 independently modulates the phase and/or amplitude of the incident optical radiation, enabling precise element-wise operations for the vector-matrix multiplication. In some embodiments, the metasurface 166 utilizes phase-change materials, such as liquid crystals, that are dynamically adjustable to allow for rapid adjustment of the modulation parameters during operation. The use of a dynamically reconfigurable metasurface allows for sequential computations of multiple vector-matrix multiplications with varying input vectors or weighting matrices, without requiring physical hardware changes.

The metasurface 166 modulates the vector-encoded optical signal to form a modulated optical signal. The modulated optical signal represents an unsummed optical vector-matrix multiplication of the input vector and the matrix. The free space optical subsystem 168 can be configured to operate to condense the modulated optical signal along a perpendicular axis (e.g., a substantially perpendicular axis) in the second free space optical path 132B as shown in FIG. 1B. The condensing operation performed by the free space optical subsystem 168 implements a summation, which completes the vector-matrix multiplication, as described in connection with FIGS. 1A-1B. As previously noted, the free space optical subsystem 168 may incorporate lenses to implement the condensing function and direct the condensed optical signal to be received by the silicon photonic receiving subsystem 170.

A silicon photonic receiving subsystem 170 (e.g., a silicon photonic receiver subsystem) detects and decodes the condensed optical signal into electronic signals. The silicon photonic receiving subsystem 170 may include, for example, an array of photodetectors capable of measuring intensity, amplitude, phase, and/or polarization. The silicon photonic receiving subsystem 170 operates to detect and convert the condensed optical signal into digital form. The output digital signal, corresponding to the resultant vector of the vector-matrix multiplication, is ready for further processing by other digital subsystems, transmission to a host via a host interface 174, and/or digital storage.

As described herein, a control circuit 172 manages data flow between the photonic subsystems and dynamically reconfigures the metasurface 166 during operation. The control circuit 172 may be an integrated control circuit. For example, the control circuit 172 may include and/or implement, for example, an application specific integrated circuit (ASIC) or an EIC. The plurality of optical modulators and the plurality of waveguides in the silicon photonic transmitter subsystem 164 may be driven by the EIC via at least one bump bond (e.g., copper bumps) or at least one through-silicon via (TSV).

The control circuit 172 may include an integrated vector processing unit (VPU) 176. The VPU 176 may perform useful post-detection operations such as accumulation, Rectified Linear Unit (ReLU) activation, and/or normalization. The post-detection operations performed by the VPU 176 are particularly useful for applications in artificial intelligence and neural network inference.

In some embodiments, the control circuit 172 includes tightly integrated memory modules to support high-speed, low-latency data storage and retrieval. For example, a monolithic static random-access memory (SRAM) 178 is co-located on the control circuit 172. The monolithic SRAM 178 may, for example, store weights and activation data, while also facilitating input operations and/or output operations. In addition, a high-bandwidth memory (HBM) module 180 may be connected to the control circuit 172 via an interposer. The HBM module 180 provides storage for large matrices and other data required for computation. The combination of integrated SRAM and high-speed connected HBM reduces latency and energy consumption during memory access operations.

In some embodiments, the HBM module 180, the SRAM 178, and the VPU 176 are accessible via the host interface 174 (e.g., via the control circuit 172). The host interface 174 connects the OVMM device 162 to external computational frameworks, enabling the upload of input vectors and matrices and the retrieval of computed results. The host interface 174 supports seamless integration with larger systems, allowing the OVMM device 162 to function as a modular and versatile computational unit. In some embodiments, the VPU configure the plurality of optical modulators in accordance with at least a portion of the weight matrix to encode the input vector

Beneficially, the illustrated architecture of the OVMM system 160 provides a balance of photonic, optical, and digital components that enable high-throughput and energy-efficient computations. The free space optical subsystem 168 allows for coplanar co-localization configuration of the silicon photonic transmitter subsystem 164, metasurface 166, and silicon photonic receiving subsystem 170 proximate to the control circuit 172.

Having described the fundamental architectures and operations of the example OVMMs of the present disclosure, attention is now turned to the encoding strategies applied by the example OVMMs. Specifically, the encoding strategies of matrix elements in an SLM (e.g., the SLM 146) and of input vectors by a TX array (e.g., the TX array 134) are detailed further below.

Integer values for matrix elements may be used for encoding as described below. A single channel on the receive (e.g., the RX array 154), R, represents one element in the product vector and captures all the mathematical operations in vector matrix multiplication

$$( \begin{matrix}{M}_{11} & ⋯ & {M}_{N 1} \\ ⋮ & ⋱ & ⋮ \\ {M}_{1 N} & ⋯ & {M}_{NN}\end{matrix} ) ( \begin{matrix}{V}_{1} \\ ⋮ \\ {V}_{N}\end{matrix} ) = ( \begin{matrix}{M}_{11} + ⋯ + {M}_{N 1} {V}_{N} \\ ⋮ \\ {M}_{1 N} {V}_{1} + ⋯ + {M}_{NN} {V}_{N}\end{matrix} ) = ( \begin{matrix}{R}_{1} \\ ⋮ \\ {R}_{N}\end{matrix} )$$

As shown above, all elements of, M, V, and R are taken to be B_{M}-bit, B_{V}-bit, and B_{R}-bit values, respectively. Generally, an element of the product vector can be defined as

$${R}_{j} = {\sum }_{i = 1}^{N} {M}_{ij} {V}_{i}$$

To encode the M matrix in the metasurface, each Mᵢⱼ can be split into two separate

$$\frac{{B}_{M}}{2} - bit$$

values with the upper

$$\frac{{B}_{M}}{2} - bits$$

corresponding to the MSBs and the lower

$$\frac{{B}_{M}}{2} - bits$$

corresponding to the LSBs based on its representation in binary, as expressed below:

$$\begin{matrix}{M}_{ij} = {\sum }_{z = 0}^{{B}_{M} - 1} {d}_{z} {2}^{z} ( {M}_{ij} represented in binary ) \\ = {2}^{{B}_{M} / 2} {\sum }_{z = 0}^{\frac{{B}_{M}}{2} - 1} {d}_{( z + {B}_{M} / 2 )} {2}^{z} + {\sum }_{z = 0}^{\frac{{B}_{M}}{2} - 1} {d}_{z} {2}^{z} \\ = ( {2}^{{B}_{M} / 2} ) {M}_{ij}^{MSB} + {M}_{ij}^{LSB}\end{matrix}$$

The term d_{z} is the binary value of each digit (either 1 or 0) and z is the digit number. For example, in some embodiments a metasurface is able to represent 8-bit integers (4-bit integers in the real domain and 4-bit integers in the imaginary domain) for a single metasurface state. In such an embodiment, the 8-bit number “217” (binary: 11011001), may be split into the MSB value of 13 (binary: 1101) and LSB value of 9 (binary: 1001). The 2^{B}^{_{M}}^{/2} term in front of the MSB is a scaling factor that will be reintroduced after the matrix multiplication is performed.

The system can normalize the two new half-precision MSB and LSB values to the maximum half-precision value, 2^{B/2}−1, and use the values to define the complex reflection coefficient for a given pixel on the metasurface, as follows:

$$\frac{{M}_{ij}^{MSB} + {iM}_{ij}^{LSB}}{{2}^{{B}_{M} / 2} - 1} = \frac{\sqrt{{( {M}_{ij}^{MSB} )}^{2} + {( {M}_{ij}^{LSB} )}^{2}}}{{2}^{{B}_{M} / 2} - 1} ( {e}^{{itan}^{- 1} ( {M}_{ij}^{LSB} / {M}_{ij}^{MSB} )} )$$

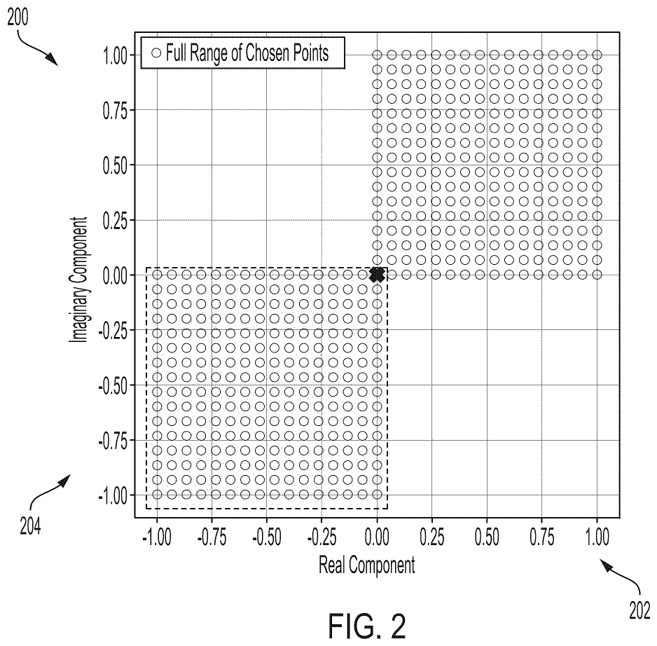

FIG. 2 illustrates an example 8-bit integer constellation diagram 200 for a metasurface. The constellation diagram 200 includes an x-axis 202 that corresponds to real components of a given metasurface element Mᵢⱼ, while a y-axis 204 corresponds to imaginary components of the given metasurface element Mᵢⱼ. Each point (shown as a solid dot in FIG. 2) on the constellation diagram 200 represents a possible state of a transmitted optical signal in terms of the real and imaginary components of the possible state. As shown, possible states the constellation diagram 200 are constrained to two quadrants.

In some embodiments, the system (e.g., the OVMM system 160 of FIG. 1C) may assign the MSB as the real component and the LSB as the imaginary component, but both modalities are equally valid. In some embodiments, the real component corresponds to an amplitude of an optical signal and the imaginary component corresponds to a phase of the optical signal. For example, the MSB maps to a real axis and the LSB maps to an imaginary axis. In some such embodiments, a receiving subsystem (e.g., the silicon photonic receiving subsystem 170) may detect the MSB and the LSB simultaneously. Such an embodiment may use coherent detection of the MSB and LSB. In some embodiments, the receiving subsystem is configured detect an in-phase component and/or quadrature component of each of the MSB and LSB simultaneously.

The set of MSB and LSB elements that span the full B_{M} precision range can be visualized as a grid of points in FIG. 2. Unlike conventional QAM encoding, the constellation contains zero values in both the real and imaginary axes, and the axes are orthogonal so that the multiplication remains self-consistent. To extend this encoding to include signed values (e.g., by adding an extra bit), the constellation can be mirrored in the third quadrant relative to the original constellation to preserve the correct signs during the addition operation of the vector matrix multiplication.

In some embodiments, the bits of each input vector element of the input vector are transmitted iteratively, utilizing the rapid modulation capabilities of silicon photonics and standard PAM encoding techniques. An iterative approach may be useful due to the physical limitations of free space optics and/or the difficulties of higher-order modulation in silicon photonics. In such embodiments, for an input vector element Vᵢ of precision B_{V}, the bits are split into smaller segments, (P_{y})ᵢ, each of precision Bₚ and sent sequentially.

$$\begin{matrix}{V}_{i} = {\sum }_{z = 0}^{{B}_{V} - 1} {d}_{z} {2}^{z} ( {V}_{i} represented in binary ) \\ = {\sum }_{y = 0}^{\frac{{B}_{V}}{{B}_{p} - 1}} {2}^{( {B}_{p} ) y} ( {\sum }_{z = 0}^{{B}_{p} - 1} {d}_{( z + {B}_{p} y )} {2}^{z} ) \\ = {\sum }_{y = 0}^{\frac{{B}_{V}}{{B}_{p}} - 1} {2}^{{B}_{p} y} {( {P}_{y} )}_{i}\end{matrix}$$

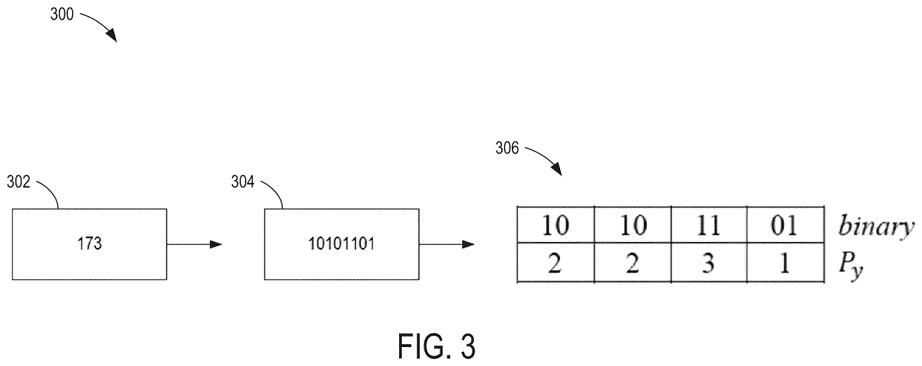

FIG. 3 illustrates an example of a binary partitioning 300 of an integer into multiple 2-bit values. In the illustrated example, an 8-bit input vector element 302 of value “173” corresponds to a binary value 304 of 10101101. The binary value 304 is partitioned into four separate 2-bit values (2, 2, 3, and 1), shown in the table 306. The system may normalize the P_{y} terms relative to the maximum value for the bit precision, Bₚ, and transmit the values using, for example, PAM-4 encoding. The system (e.g., the OVMM system 160) may use the accompanying coefficients for each term, 2^{B}^{ₚ}^{y}, as scaling factors reintroduced after the vector matrix multiply is performed for each P_{y}.

The transmitted optical field for each input vector element is expressible as:

$${P}_{y} ⇒ \frac{abs ( {P}_{y} )}{{2}^{{B}_{p}} - 1} ( {e}^{i ( kx - ω t + φ )} )$$

$$φ = \frac{π}{2} ( 1 - sign ( {P}_{y} ) ) = \{ \begin{matrix}0 & if & {P}_{y} \geq 0 \\ π & if & {P}_{y} < 0\end{matrix}$$

The terms k, ω are the wavenumber and angular frequency of the optical field, respectively. Ther term φ is the phase offset and is nonzero if negative values are included. As previously described, the system may transmit each P_{y} sequentially for the full representation of the element Vᵢ. The variables x and t are the standard distance and time for the propagation of an optical field.

The operational flow of one static metasurface representation with an iterative input vector (e.g., the input vector 104) is provided as an example of how the OVMM system (e.g., the OVMM system 160) extracts the product, R. For example, the control circuit 172 may be configured to extract the product R by performing the example described below.

With a single state of the metasurface, the input bit precision is inherently limited by the precision limit of the metasurface. For example, if the metasurface has 8-bit precision and the transmitter is inputting 2-bit values, the pointwise multiplication may be a 10-bit representation and, when including addition, which increases further by ceil (log 2(N)). Thus, for the matrix and input vector elements, Mᵢⱼ and Vᵢ, respectively, the product vector elements, Rⱼ, can be expressed as:

$${R}_{j} = {\sum }_{i = 1}^{N} {M}_{ij} {V}_{i} = {\sum }_{i = 1}^{N} ( ( ( {2}^{{B}_{M} / 2} ) {M}_{ij}^{MSB} + {M}_{ij}^{LSB} ) {\sum }_{y = 0}^{\frac{{B}_{V}}{{B}_{p}} - 1} {2}^{{B}_{p} y} {( {P}_{y} )}_{i} )$$

This definition of Rⱼ, while accounting for the expanded representation of each element to accommodate the limited bit precision, does not demonstrate the actual transmitted signal. Taking it a step further, the product optical field, (E_{y})ⱼ, from each input, P_{y}, that is coupled into each silicon photonic receiver channel is as follows:

$${( {E}_{y} )}_{j} = {\sum }_{i = 1}^{N} ( ( \frac{{M}_{ij}^{MSB} + {iM}_{ij}^{LSB}}{{2}^{{B}_{M} / 2} - 1} ) ( \frac{{abs ( {P}_{y} )}_{i}}{{2}^{{B}_{p}} - 1} ( {e}^{i ( kx - ω t + φ )} ) ) )$$

The system normalizes the segmented values for both the metasurface,

$${M}_{ij}^{MSB} and {M}_{ij}^{LSB} ,$$

and the input vector, (P_{y})ᵢ, by the maximum representable value for their respective encodings. Thus, the measured field, (E_{y})ⱼ, is a relative value that the system can rescale upon measurement. The full Rⱼ can be recovered from the complex (E_{y})ⱼ. The system may use measured or programmed values for the propagation distance, x, and the flight time, t. Alternatively, the system may use null values (zero) for the system propagation distance, x, and the flight time, t. The system may use a QAM detection scheme to separate the real and imaginary components, as follows:

$${Real ( {E}_{y} )}_{j} = {\sum }_{i = 1}^{N} ( ( \frac{{M}_{ij}^{MSB}}{{2}^{{B}_{M} / 2} - 1} ) ( \frac{{abs ( {P}_{y} )}_{i}}{{2}^{{B}_{p}} - 1} ( {e}^{i ( kx - ω t + φ )} ) ) ) ⇒ {\sum }_{i = 1}^{N} ( \frac{{M}_{ij}^{MSB}}{{2}^{{B}_{M} / 2} - 1} ) ( \frac{{abs ( {P}_{y} )}_{i}}{{2}^{{B}_{p}} - 1} )$$

$${Imag ( {E}_{y} )}_{j} = {\sum }_{i = 1}^{N} ( ( \frac{{M}_{ij}^{LSB}}{{2}^{{B}_{M} / 2} - 1} ) ( \frac{{abs ( {P}_{y} )}_{i}}{{2}^{{B}_{p}} - 1} ( {e}^{i ( kx - ω t + φ )} ) ) ) ⇒ {\sum }_{i = 1}^{N} ( \frac{{M}_{ij}^{LSB}}{{2}^{{B}_{M} / 2} - 1} ) ( \frac{{abs ( {P}_{y} )}_{i}}{{2}^{{B}_{p}} - 1} )$$

With the scaling factors for both the metasurface and the input vector included, the full value of Rⱼ can be expressed as:

$${R}_{j} = {\sum }_{y = 0}^{\frac{{B}_{V}}{{B}_{p}} - 1} {( {R}_{y} )}_{j} = {\sum }_{y = 0}^{\frac{{B}_{V}}{{B}_{p}} - 1} ( {2}^{{B}_{p} y} ) ( {2}^{{B}_{p}} - 1 ) ( {2}^{{B}_{M} / 2} - 1 ) ( ( {2}^{{B}_{M} / 2} ) {Real ( {E}_{y} )}_{j} + {Imag ( {E}_{y} )}_{j} )$$

The summation over y accounts for the iterative splitting of the input vector in precision. As an example, the first product element, R₁, of a 2×2 vector-matrix multiplication can be derived as follows:

$$( \begin{matrix}{M}_{11} & {M}_{21} \\ \sim & \sim\end{matrix} ) ( \begin{matrix}{V}_{1} \\ {V}_{2}\end{matrix} ) = ( \begin{matrix}{R}_{1} \\ \sim\end{matrix} ) ⇒ {M}_{11} {V}_{1} + {M}_{21} {V}_{2} = {R}_{1}$$

In some embodiments, a system (e.g., the OVMM system 160) is configured to iteratively split the input vector with a scaling coefficient. For example, the system may iteratively split the input vector as described above. In some embodiments, the system may be configured to rescale resulting measurements by the scaling factor. In some embodiments, the scaling coefficient is 2^{B}^{ₚ}^{·y}. In other embodiments, the scaling coefficient is 2^{B}^{_{M}}^{/2}.

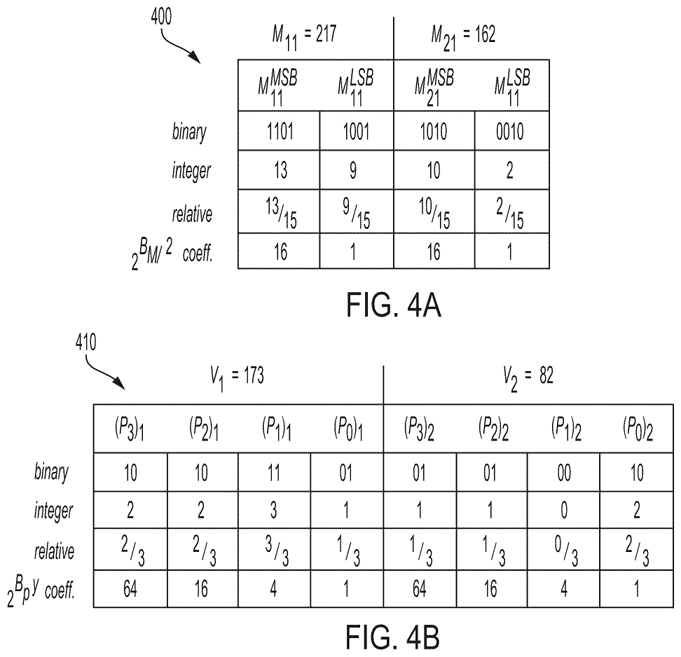

FIGS. 4A-4B illustrates tables of segmented values relating to the operational flow of one static metasurface representation with an iterative input vector. FIG. 4A is a table 400 of segmented matrix values when M₁₁=217 and when M₂₁=162. FIG. 4B is a table 410 of segmented input vector values when V₁=173 and when V₂=82. In the illustrated example, given that

$${B}_{V} = 8 and {B}_{p} = 2 , \frac{{B}_{V}}{{B}_{p}} = 4 ,$$

and thus the system may collect four separate measurements, as follows:

$$Measurement 1 : {( {E}_{0} )}_{1} = ( {M}_{11}^{MSB} + {iM}_{11}^{LSB} ) {( {P}_{0} )}_{1} + ( {M}_{21}^{MSB} + {iM}_{21}^{LSB} ) {( {P}_{0} )}_{2} = \frac{33}{45} + i \frac{13}{45}$$

$$Measurement 2 : {( {E}_{1} )}_{1} = ( {M}_{11}^{MSB} + {iM}_{11}^{LSB} ) {( {P}_{1} )}_{1} + ( {M}_{21}^{MSB} + {iM}_{21}^{LSB} ) {( {P}_{1} )}_{2} = \frac{39}{45} + i \frac{27}{45}$$

$$Measurement 3 : {( {E}_{2} )}_{1} = ( {M}_{11}^{MSB} + {iM}_{11}^{LSB} ) {( {P}_{2} )}_{1} + ( {M}_{21}^{MSB} + {iM}_{21}^{LSB} ) {( {P}_{2} )}_{2} = \frac{36}{45} + i \frac{20}{45}$$

$$Measurement 4 : {( {E}_{3} )}_{1} = ( {M}_{11}^{MSB} + {iM}_{11}^{LSB} ) {( {P}_{3} )}_{1} + ( {M}_{21}^{MSB} + {iM}_{21}^{LSB} ) {( {P}_{3} )}_{2} = \frac{36}{45} + i \frac{20}{45}$$

Using these (Ey)₁ measurements, the system may digitally reintroduce the scaling factors to calculate (Ry)₁ values, as follows:

$${( {R}_{0} )}_{1} = ( {2}^{2 \times 0} ) ( {2}^{2} - 1 ) ( {2}^{8 / 2} - 1 ) ( ( {2}^{8 / 2} ) \frac{33}{45} + \frac{13}{45} ) = 16 ( 33 ) + 13 = 541$$

$${( {R}_{1} )}_{1} = ( {2}^{2 \times 1} ) ( {2}^{2} - 1 ) ( {2}^{8 / 2} - 1 ) ( ( {2}^{8 / 2} ) \frac{39}{45} + \frac{27}{45} ) = 4 [ 16 ( 39 ) + 27 ] = 2604$$

$${( {R}_{2} )}_{1} = ( {2}^{2 \times 2} ) ( {2}^{2} - 1 ) ( {2}^{8 / 2} - 1 ) ( ( {2}^{8 / 2} ) \frac{36}{45} + \frac{20}{45} ) = 16 [ 16 ( 36 ) + 20 ] = 9536$$

$${( {R}_{3} )}_{1} = ( {2}^{2 \times 3} ) ( {2}^{2} - 1 ) ( {2}^{8 / 2} - 1 ) ( ( {2}^{8 / 2} ) \frac{36}{45} + \frac{20}{45} ) = 64 [ 16 ( 36 ) + 20 ] = 38144$$

The system may sum the (Ry)₁ components to determine that R₁=50825. Notably, this computation matches the straightforward multiplication of the input vector with the matrix row:

R₁=M₁₁V₁+M₂₁V₂=217(173)+162(82)=50825

In some embodiments, the system electronically (e.g., digitally) computes the multiplication of the scaling factors as well as the summation of the (R_{y})ⱼ elements. In many embodiments, digital computation of the multiplication of the scaling factors and the summation of the (Ry)ⱼ elements may be used to scale to precisions beyond the tolerancing of the optical system. The multiplication scaling factors 2^{B}^{ₚ}^{y} and 2^{B}^{_{M}}^{/2} are power-of-2 scalers, which translates to bit-shifting of the (E_{y})ⱼ values followed by an addition operation of all (R_{y})ⱼ terms. Accordingly, the overhead of the electronic operations is relatively small.

The systems and methods described above in the context of FIGS. 2-4 are for a single-cycle OVMM system. The single-cycle OVMM systems and methods may be sufficient and suitable in some applications and implementations. However, the bit-precision of a single-cycle OVMM system is limited to the precision capabilities of the metasurface. Beneficially, as described herein and in greater detailed below, multi-cycle OVMM systems and methods can be used to attain a target or arbitrary precision. In such embodiments, increased precision is available by using more cycles of the metasurface. For example, the metasurface may be configured to perform precision reconstruction, where high-precision weight matrices are represented in the OVMM system beyond the maximum resolution of the OVMM system.

For instance, to achieve B_{A}=64-bit precision OVMM with a metasurface capable of B_{M}=8-bit precision, the system may divide each 64-bit element, Mᵢⱼ, into eight separate 8-bit segments

$$( \frac{{B}_{A}}{{B}_{M}} = 8 ) .$$

The system may split each of these 8-bit segments into the real and imaginary components as described above. This approach can be general expressed as follows:

$${M}_{ij} = {{\sum }^{\frac{{B}_{A}}{{B}_{M} - 1}}}_{k = 0} {2}^{{B}_{M} k} {( {M}_{k} )}_{ij} = {{\sum }^{\frac{{B}_{A}}{{B}_{M}} - 1}}_{k = 0} {2}^{{B}_{M} k} {( ( {2}^{{B}_{M} / 2} ) {M}_{k}^{MSB} + {M}_{k}^{LSB} )}_{ij}$$

According to some embodiments, the system architecture can scale the input vector to arbitrary bit precision by segmenting the values into lower precision components and iteratively transmitting them. The system may use 32 iterations to attain complete 64-bit precision (B_{A}=B_{V}=64) with 2-bit segments of precision (Bₚ=2-bit) since

$$( \frac{{B}_{A}}{{B}_{p}} = 32 ) .$$

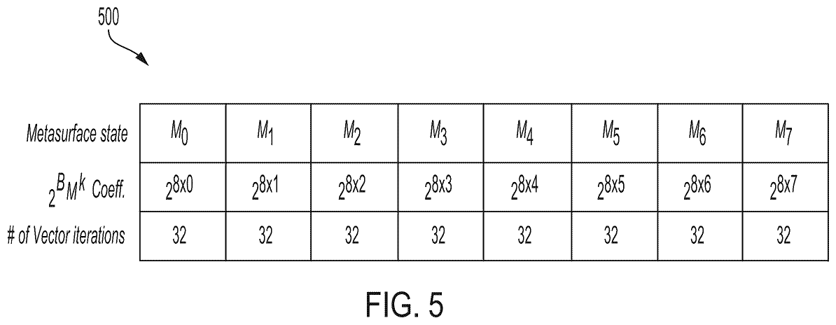

FIG. 5 illustrates a table 500 of metasurface states, coefficient values, and vector iteration counts.

As illustrated, a 64-bit precision OVMM system may use 256 measurements with 8 metasurface states for encoding the integer representation. In some embodiments, the system may use a modified version of this encoding approach for fixed point representations by using an additional scalar, which the system can digitally apply after the optical computation to account for the number of decimal places. The generalized expression for the full arbitrary bit-precision integer vector matrix multiplication is expressible as follows:

$${R}_{j} = {{\sum }^{\frac{{B}_{A}}{{B}_{M}} - 1}}_{k = 0} {2}^{{B}_{M} k} {{\sum }^{\frac{{B}_{V}}{{B}_{p}} - 1}}_{y = 0} {2}^{{B}_{p} y} ( {2}^{{B}_{p}} - 1 ) ( {2}^{{B}_{M} / 2} - 1 ) ( {\sum }_{i = 1}^{N} {( \frac{( {2}^{{B}_{M} / 2} ) {M}_{k}^{MSB} + {M}_{k}^{LSB}}{{2}^{{B}_{M} / 2} - 1} )}_{ij} ( \frac{{abs ( {P}_{y} )}_{i}}{{2}^{{B}_{p}} - 1} ( {e}^{i ( kx - ω t + φ )} ) ) )$$

In some embodiments, an OVMM system implements a floating-point (FP) representation with a target precision. The OVMM system may split the bits for a given bit precision into three parts: a sign bit, exponent bits, and mantissa bits. The sign bit may be a single bit. For example, the sign bit may be the MSB by 2's complement, used to signify whether the value is positive or negative. The next set of bits following the sign bit may be the exponent bits, which as its name implies, translates to an integer used as an exponent on a selected number base (e.g., 2 for binary, 10 for decimal, etc.). The bits following the exponent bits may be the mantissa (or fractional) bits. The mantissa acts as coefficient whose value does not exceed the base. Thus, the floating-point number is expressible as:

FP Number=(±sign)(Mant)(base)^{Exp}

As such, an FP representation is specified by the number of exponent and mantissa bits. A floating-point multi-cycle OVMM system may, for example, implement 16-bit precision using Google's brain float 16 (BF16) with E8M7 and/or Institute of Electrical and Electronics Engineers (IEEE) FP16 with E5M10. BF16 has 8 exponent bits and 7 mantissa bits, while FP16 has 5 exponent bits and 10 mantissa bits. Both BF16 and FP16 implicitly have 1 bit for the sign. In other embodiments, the FP OVMM system may utilize a floating-point representation with customized biasing and ranges for the exponent.

Unlike integer and fixed-point representations which have evenly spaced values (i.e. the LSB is also the stride between nearest values), FP allows the step-size to increase with each higher power of the exponent. This is by design so that values increase nonlinearly across the range, thereby increasing the overall dynamic range of spanned values with fewer bits than integer/fixed-point.

In some embodiments, the FP OVMM system utilizes an extended version of the IEEE standard in which the typical corner case definitions of too and NaN are utilized for actual values. For example, embodiments of an FP OVMM system may follow the IEEE definition by broadly dividing the range of floating-point values into two categories by the value of the exponent bits: ‘Subnormal’ where the exponent bits are all zero and ‘Normal’ where at least one exponent bit is nonzero. As such, for a given number of exponent bits, BE, the actual biased exponent for each type can be translated into a numerical value by:

$$Subnormal : Exp = - ( {2}^{( {B}_{E} - 1 )} - 2 )$$

$$Normal : Exp = - ( {2}^{( {B}_{E} - 1 )} - 1 ) + {\sum }_{z = 0}^{{B}_{E} - 1} ( {d}_{z} ) {2}^{( z )}$$

Again, the term d_{z} is the binary value of each digit (either 1 or 0) and z is the digit number. Similarly, for a mantissa of precision B_{μ}, the value for the normal and subnormal cases take the form:

$$Subnormal : Mant = ( \frac{1}{{2}^{{B}_{μ}}} ) {\sum }_{z = 0}^{{B}_{μ} - 1} ( {d}_{z} ) {2}^{( z )}$$

$$Normal : Mant = 1 + ( \frac{1}{{2}^{{B}_{μ}}} ) {\sum }_{z = 0}^{{B}_{μ} - 1} ( {d}_{z} ) {2}^{( z )}$$

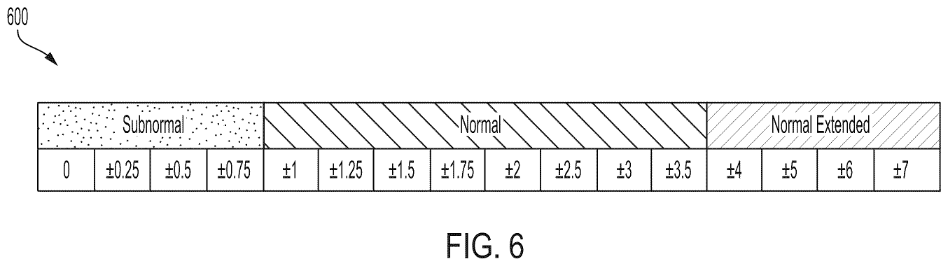

FIG. 6 illustrates a table 600 of the defined range for an extended IEEE FP5 with 2 exponent bits and 2 mantissa bits (E2M2).

The “Normal Extended” range of values arise from ignoring the corner cases in the IEEE standard for ±∞ and NaN that are abortive in the optical component of the vector matrix multiply. Unlike standard IEEE floating-point where the maximum exponent is (2^{(B}^{_{E}}⁻¹⁾−1), for this extended variation it simplifies to 2^{(B}^{_{E}}⁻¹⁾. Therefore, the maximum FP value (e.g., the threshold FP value) for a given FP precision is:

$${FP}_{max} = ( 1 + \frac{{2}^{{B}_{μ}} - 1}{{2}^{{B}_{μ}}} ) {2}^{( {2}^{( {B}_{E} - 1 )} )}$$

One challenge to encoding floating-point is reconciling FP's nonlinear range and varied step-size with the approximately linear tuning of the metasurface. As described herein, the optical tolerances of components within an OVMM limit the precision, so the expressible precisions for FP are constrained even more so than integer and fixed-point representations. In some embodiments, an FP OVMM system may leverage the two-dimensional tunability of the metasurface in the complex plane to alleviate some of the precision constraints.

According to some embodiments, an FP OVMM system may be capable of using one or more FP encoding approaches to encoding a metasurface. The FP encoding approaches described herein provide improved or optimal mappings of the nonlinear floating-point range onto the linear tuning capabilities of the metasurface. The approaches may, for example, prioritize magnitude-based segmenting of a value over bit-level splitting on the FP representation itself to leverage the two-dimensional tunability. The FP encoding approach selected for a particular application may be, for example, selected to maximize the projectable precision onto the metasurface to minimize the required number of switching cycles. Cost, efficiency, and specific use-cases may warrant the use of different FP encoding approaches. Examples of some possible FP encoding approaches, each of which is described in greater detail below, include a cosine projection with single axis dependency, cosine projection with dual axis dependency (modulo), on-axis range split, and modulo split with independent axes.

In some embodiments, the OVMM system utilizes a cosine projection with single axis dependency encoding approach. One challenge in mapping a floating-point range to a linear system is the step-size at low absolute values. For instance, to project FP5 (E2M2) onto the metasurface, the entire range may be normalized by the maximum absolute value which reduces the lowest nonzero value (and smallest step-size) to 1/28. For distinguishability between values, this requires a precision better than 1/56, (e.g., half the step-size). This is a fairly high precision to accommodate on a linear scale. Accordingly, in some embodiments, the OVMM system may leverage the two-dimensional tunability of the metasurface by using the second dimension to increase the spacing between constellation points. For example, a metasurface element may be tuned such that it represents the value Mᵢⱼ along one axis but is then projected vertically upward to maximize its distance from neighboring constellation points. This action can be expressed quantitatively according to the following relation:

Mᵢⱼ=Aᵢⱼ cos θᵢⱼ=Real(Aᵢⱼ^{e}^{^{iθ}}^{ij})

The term θᵢⱼ is the angle relative to the axis of measurement (the reference “zero” phase axis) and Aᵢⱼ is the magnitude of the reflection coefficient. Given that Aᵢⱼ and θᵢⱼ are independent values, there are a wide array of values that satisfy the expression allowing for flexibility in choosing the exact location of the constellation point.

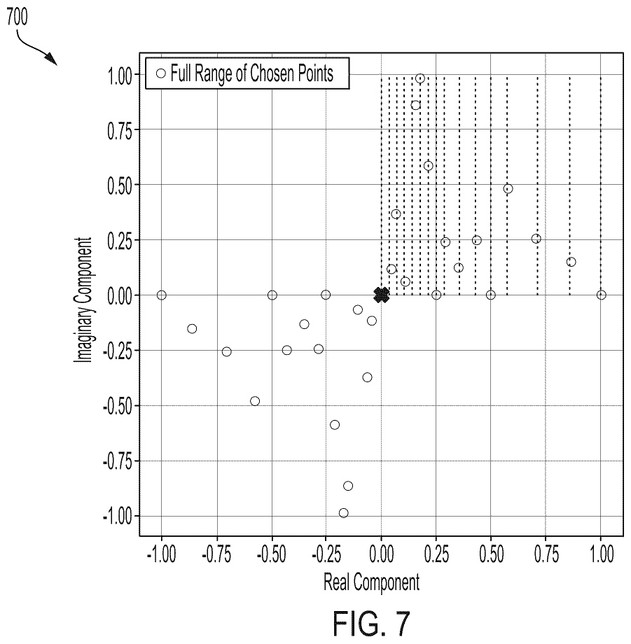

FIG. 7 illustrates an example of an FP5 (E2M2) constellation diagram 700 for a metasurface (e.g., SLM 146 or metasurface 166).

The illustrated set of constellation points satisfies FP5 (E2M2). Any point chosen along each of the green vertical lines would satisfy that specific FP value, hence this method is adaptable to the achievable tuning states of the metasurface. The actual representation of a given value Mᵢⱼ on the metasurface corresponds to:

$$\frac{{A}_{ij}}{{FP}_{max}} {e}^{i {θ}_{ij}} where \frac{{A}_{ij}}{{FP}_{max}} \leq 1$$

Another advantage to the cosine projection with single axis dependency encoding approach is that the measurement is only happening along a single axis, so there may be no need for a complicated QAM-style measurement scheme with multiple detectors. Instead, embodiment of FR OVMMs utilizing the cosine projection with single axis dependency approach may operate with only a single detector. While this method enables the expression of individual tightly packed small values, what is measured is the summation mu along a given column. Thus, it is not necessary in measurement to distinguish the individual values as long as they are contributing to the sum.

In some embodiments, the OVMM system utilizes a cosine projection with dual axis dependency (modulo) encoding approach. One potential weakness of the cosine projection with single axis dependency is that the accuracy with which the lower significant bits can be measured may be limited. The cosine projection with dual axis dependency encoding approach projects the complete FP values onto a single axis and additionally utilizes the orthogonal axis to better measure the lower significant bits. In some embodiments, the OVMM system implements a modulo operation on the FP range with a particular value in the range chosen as the modulus. Thus, to encode an FP value for a given matrix element, Mᵢⱼ, the metasurface projection is as follows:

$${M}_{ij} ⇒ \frac{{M}_{ij}}{{FP}_{max}} + i \frac{mod ( {M}_{ij} , K )}{K}$$

The term K is the modulus and mod(Mᵢⱼ,K) is the remainder of the modulo of Mᵢⱼ with respect to K.

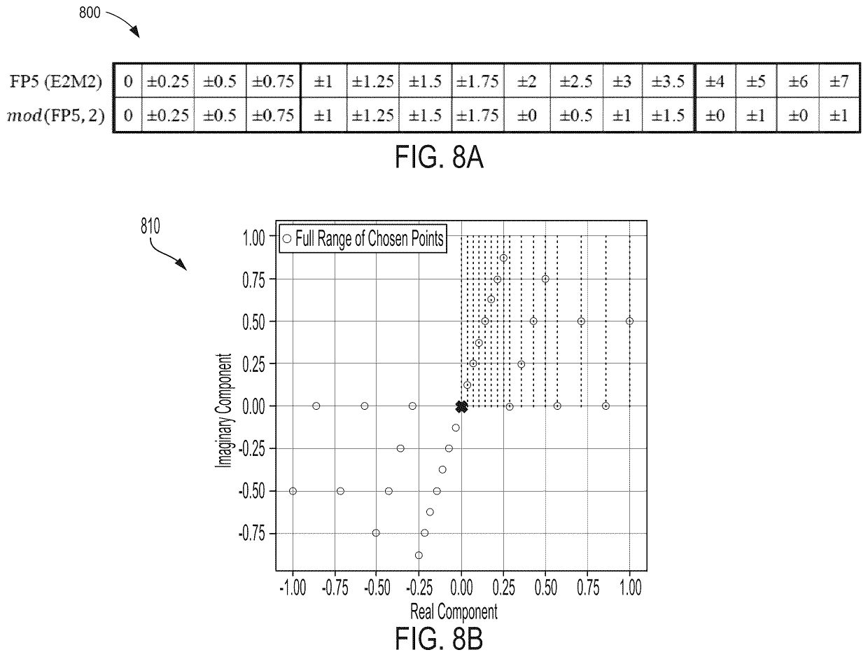

FIG. 8A illustrates a table 800 of FP5 (E2M2) values mod(FP5, 2) values.

In some embodiments, the value of 2 is used as the modulus, K, because not only is it approximately the median absolute value, but it is also a power of 2, which when converted back to binary provides a clear demarcation point between upper and lower bits. An example vector-matrix multiplication is shown below:

$$( \begin{matrix}4 & 3.5 & 0.75 & 5 \\ \sim & \sim & \sim & \sim \\ \sim & \sim & \sim & \sim \\ \sim & \sim & \sim & \sim\end{matrix} ) ( \begin{matrix}1.25 \\ 1.5 \\ 2 \\ 3.5\end{matrix} ) = ( \begin{matrix}{R}_{1} \\ ∼ \\ ∼ \\ ∼\end{matrix} )$$

The value of R₁ is 29.25 in the vector-matrix multiplication above. A pointwise mod(2) is performed on the matrix below and the resultant remainder matrix is multiplied by the original input vector:

$$( \begin{matrix}0 & 1.5 & 0.75 & 1 \\ ∼ & ∼ & ∼ & ∼ \\ ∼ & ∼ & ∼ & ∼ \\ ∼ & ∼ & ∼ & ∼\end{matrix} ) ( \begin{matrix}1.25 \\ 1.5 \\ 2 \\ 3.5\end{matrix} ) = ( \begin{matrix}{( {R}_{1} )}_{mod} \\ \sim \\ \sim\end{matrix} )$$

The product is (R1)_{mod}=7.25. The OVMM compute architecture may operate to convert both products R₁ and (R₁)_{mod} back into linear binary values (e.g., integer or fixed-point) after measurement by the photodetectors. Specifically, the OVMM system may convert the results back to fixed-point binary such that R₁=29.25=11101.01 and (R₁)_{mod}=7.25=00111.01.

It is apparent that the bits for both R₁ and (R₁)_{mod} match below the chosen modulus-bit, the 2-bit in this example. While the original product, R₁, contains the full magnitude, the (R₁)_{mod} result can potentially provide a more accurate measurement of the bits below the modulus.

FIG. 8B illustrates an example of a mod(FP5, 2) constellation diagram 810 for a metasurface (e.g., the SLM 146 or the metasurface 166).

As illustrated, the scaling on each axis results in a more accurate measurement of the bits below the modulus for the (R₁)_{mod} result. The values on the real axis are normalized to FPₘₐₓ. In contrast, the values on the imaginary axis (the remainders of the modulo operation) are normalized to the modulus. Accordingly, in some embodiments an OVMM system may fully leverage the cosine projection with dual axis dependency (modulo) encoding approach by combining the most significant bits above and including the modulus from the real axis with the least significant bits below the modulus from the imaginary axis.

A controlled selection not only increases the separation between constellation points but allows for a potentially high signal to noise ratio measurement of the lower bits. Such embodiments may be especially useful when the over vector-multiply product for a given element, Rⱼ, has a low overall magnitude. Conversely, a potential weakness is that the OVMM result along the imaginary axis of remainders is only accurate up to the modulus value. Consequently, if the matrix dimension, N, is very large, the bits below the modulus may constitute a very small portion of the overall bit length.

In some embodiments, the OVMM system utilizes an on-axis range split encoding approach. In contrast to the previously described encoding approaches, which project the entire value onto one axis, the on-axis range split encoding approach splits the floating-point range between the two orthogonal axes. The system may segment the range and project it onto the metasurface as follows:

$${M}_{ij} ⇒ \{ \begin{matrix}{M}_{ij} / {FP}_{max} & if {M}_{ij} > K \\ {M}_{ij} / K & if {M}_{ij} \leq K\end{matrix}$$

The threshold value, K, may, for example, be a power of 2 value for simplicity of segmenting the range when in a linear binary representation.

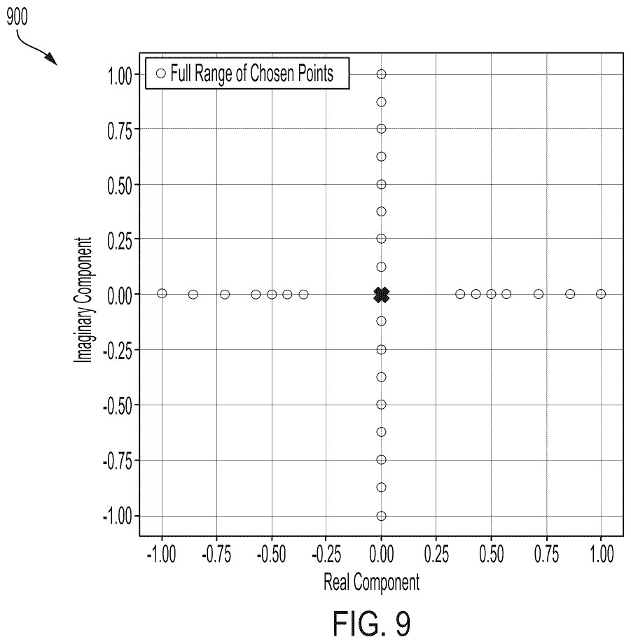

FIG. 9 illustrates a constellation diagram 900 for FP5 (E2M2) with the range split between two axes.

Each matrix element, Mᵢⱼ, is only nonzero on one axis, but each resultant product vector element, Rⱼ, is dependent upon both. Accordingly, a QAM-style measurement is used. Since the FP range is split independently between the two axes, the system sums the resultant products for each orthogonal axis for the full value of Rⱼ.

In some embodiments, the OVMM system utilizes a modulo split with independent axes encoding approach. The modulo split with independent axes encoding approach is a generalization of both the modulo operation approach and the integer representation approach. In such embodiments, the system expresses any number, and hence any matrix element, Mᵢⱼ, as the sum:

Mᵢⱼ=G_{M}×K+mod(Mᵢⱼ,K)

The term K is the modulus, mod(Mᵢⱼ,K) is the remainder of the modulo function, and G is the largest number from the range, such that Mᵢⱼ≥G×K. With Mᵢⱼ separated into the sum of two components, the system encodes each summand onto the metasurface, where each summand corresponds to the value projected on each axis. This translates directly back to the integer MSB-LSB split approach described herein, which can be directly converted via:

$${G}_{M} = {M}_{ij}^{MSB}$$

$$K = {2}^{{B}_{M} / 2}$$

$$mod ( {M}_{ij} , K ) = {M}_{ij}^{LSB}$$

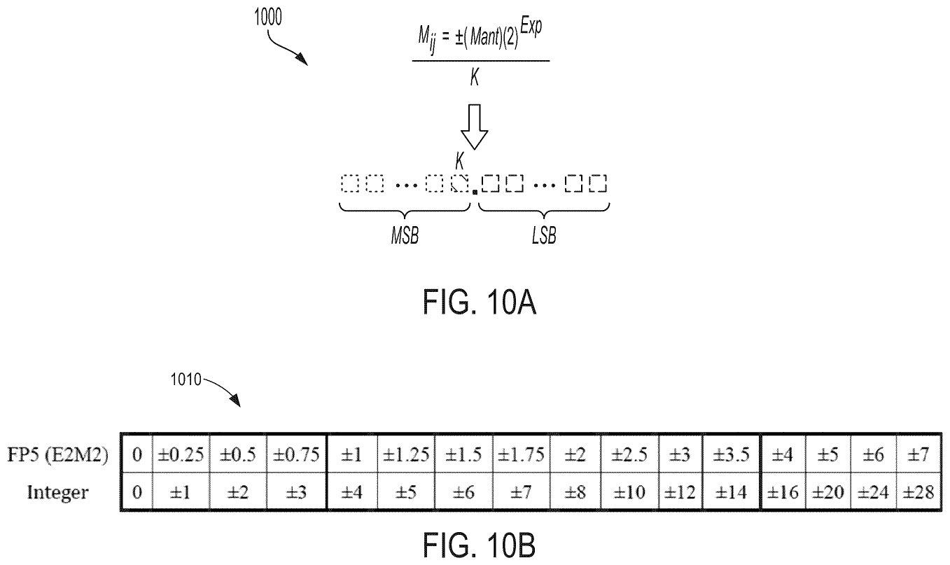

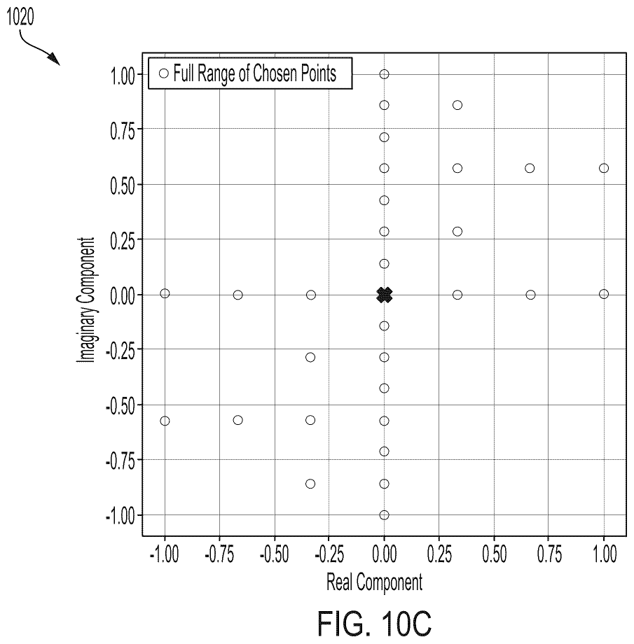

FIG. 10A is a diagram 1000 illustrating a modulus value, K, used to establish a split between the MSB and the LSB.

A modulus that is a power of 2 is used in some embodiments, especially given that all representations in this architecture are binary. For example, given an FP representation, the decision of which bits are represented on each axis comes down to converting the FP representation to fixed-point after dividing the (2) Exp term by the modulus, K. The mantissa bits≥1 may be considered the MSB value, whereas remaining mantissa bits would become the LSB value.

FIG. 10B illustrates a table 1010 showing conversion from the FP5 (E2M2) to a sparse integer range.

As previously described, the system may convert a given FP range to a sparse integer range by dividing each value in the range by the smallest absolute nonzero value. When converting an FP range to integer values, the largest integer is given by:

$${FP}_{max}^{int} = \frac{{FP}_{max}}{{FP}_{min}} = {2}^{( {2}^{( {B}_{E} ) + {B}_{μ} - 1} )} - {2}^{( {2}^{( {B}_{E} )} - 2 )}$$

From this expression, the system may determine that a given FP range spans a signed integer range of (2^{(B}^{_{E}}⁾+B_{μ})-precision after conversion. The comparable integer MSB-LSB split would need to be taken at K=2 ((2^{(B}^{_{E}}^{)+B}^{_{μ}}^{-1)/2}) for the converted integer range to produce all the positive constellation points, with the 2's complement sign-bit not being included. Accordingly, the sign bit may be repeated in both the newly split MSB & LSB. For example, FP5 requires 6-bits in signed integer representation to cover the full dynamic range and would allocate 2-bits to the MSB and 3-bits for the LSB in the integer representation.

FIG. 10C illustrates a constellation diagram 1020 for FP5 (E2M2) with mod(2) projected onto the metasurface.

Some embodiments of FP OVMM systems utilize an encoding approach based on a modulo split with independent axes. The modulo split with independent axes encoding approach flexibly allows for a systematic division of precision between the two axes with any choice of modulus in any type of representation.

The encoding approaches described above may be employed for encoding a matrix (e.g., the two-dimensional modulation matrix 114) on the two-dimensional tunable metasurface (e.g., the SLM 146 or the metasurface 166). As previously described, the OVMM system 160 may also encode a representation of an input vector in an optical signal. For example, the OVMM device 130 encodes the input vector in TX elements 136 of the TX array 134. In some embodiments, the OVMM system may encode FP representations of the input vector using an iterative low-precision approach for integer representation. According to some embodiments, the OVMM system may encode the input vector using a conversion to linear representation approach, using cyclic FP iterations, and/or other approaches.

In some embodiments, the OVMM system may encode the input vector by converting the FP representation to a linear representation, such as a fixed-point or integer representation, and iterating through a set number of segments of a lower dynamic range. This approach can be generalized to any linear representation via the modulo function, as follows:

$${V}_{i} = {\sum }_{y = 0}^{{G}_{V} - 1} ( {K}^{y} ) mod ( {floor}_{LSB} ( \frac{{V}_{i}}{{K}^{y}} ) , K ) where {G}_{V} = {floor}_{int} ( \frac{{V}_{i}}{K} )$$

The term K is the modulus and floor_{LSB}(x) is the function that rounds the value x down to the smallest LSB in the representation. This formalism can be translated back specifically for the case of binary integer representation through the following relations:

$${G}_{V} = \frac{{B}_{V}}{{B}_{p}} {K}^{y} = {2}^{{B}_{p} y} {( {P}_{y} )}_{i} = mod ( {floor}_{LSB} ( \frac{{V}_{i}}{{K}^{y}} ) , K )$$

The system can convert a binary FP representation into a signed linear binary representation,

$${V}_{i}^{lin} , of precision {B}_{V}^{lin} = ( {2}^{( {B}_{E} )} + {B}_{μ} ) .$$

The number iterations necessary to retrieve the full precision of a given the FP vector value in the linear representation is:

$$Linear Representation Iterations = ceil ( \frac{{2}^{( {B}_{E} )} + {B}_{μ}}{{B}_{p}} )$$

The term Bₚ is the precision of each transmitted segment and ceil (x) is a function that rounds x up to the closest integer. In some embodiments, the silicon photonic transmit module of the OVMM system may be relegated to only absolute value inputs without a π-phase shift option to represent negative values. In such embodiments, the OVMM system may transform the signed representation into an unsigned representation by removing the sign bit and adding the value 2⁽²^{^{(B}}^{E}^{⁾}^{+B}^{_{μ}}⁻¹⁾ to all

$${V}_{i}^{lin}$$

values when would maintain the precision of

$${V}_{i}^{lin} ,$$

albeit unsigned. This changes the optical vector matrix multiplication to:

$${\sum }_{i = 1}^{N} {M}_{ij} {V}_{i}^{lin} = {R}_{j} ⇒ {\sum }_{i = 1}^{N} {M}_{ij} ( \frac{{( {V}_{i}^{lin} )}^{⋆}}{( {V}_{l}^{lin} + {2}^{( {2}^{( {B}_{E} )} + {B}_{μ} - 1 )} )} ) = {R}_{j} + ( {2}^{( {2}^{( {B}_{E} )} + {B}_{μ} - 1 )} ) {\sum }_{i = 1}^{N} {M}_{ij}$$

The final measured product has an extra term beyond the desired Rⱼ. The extra term is a vector comprised of the summation of all matrix element components along each column multiplied by a correction factor. The system acquires the matrix summation solution by transmitting an input vector of all unitary values and measuring the result, or by digitally calculating the solution (e.g., outside of the OVMM). Regardless, the system acquires the solution of Rⱼ by digitally subtracting the extra term off of the measured results:

$${R}_{j} = {\sum }_{i = 1}^{N} {M}_{ij} ( {V}_{i} + {2}^{( {2}^{( {B}_{E} )} + {B}_{μ} - 1 )} ) - ( {2}^{( {2}^{( {B}_{E} )} + {B}_{μ} - 1 )} ) {\sum }_{i = 1}^{N} {M}_{ij}$$

Even with this offset of the Vᵢ elements and, in some embodiments, subtraction after the OVMM, it is still compatible with segmenting the bits of the offset vector elements,

$${( {V}_{i}^{lin} )}^{★} ,$$

for iterative transmit:

$${( {V}_{i}^{lin} )}^{★} = {\sum }_{y = 0}^{( \frac{{B}_{V}^{lin}}{{B}_{p}} ) - 1} {2}^{{B}_{p} y} {( {P}_{y} )}_{i}$$

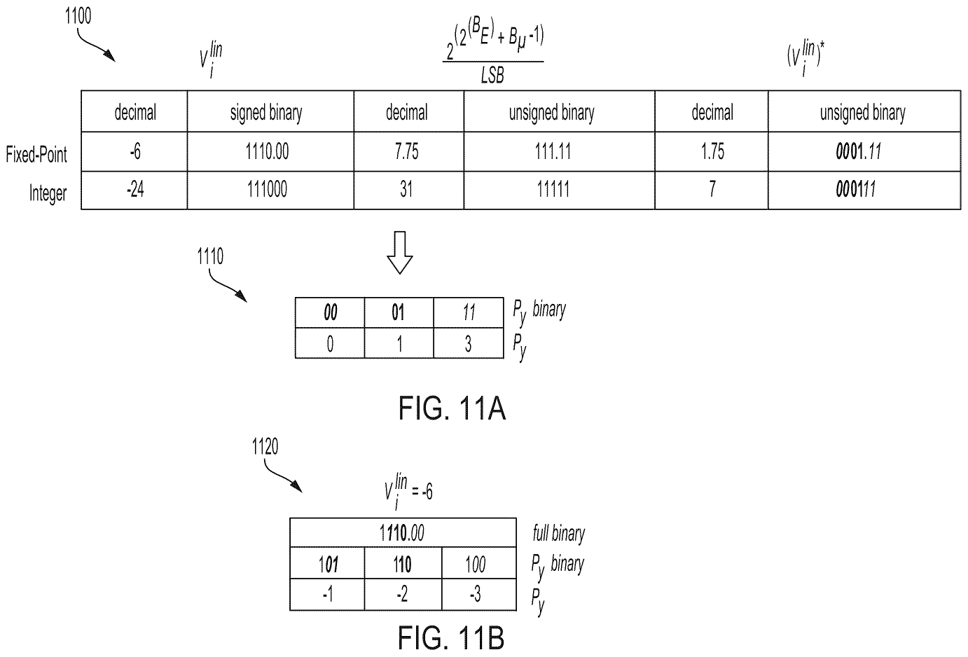

FIG. 11A illustrates tables showing how a signed value can be encoded, offset, and split for use in the described optical system. The table 1100 shows the relationship between the linear binary representation of a vector element

$${V}_{i}^{lin}$$

and the offset vector element

$${( {V}_{i}^{lin} )}^{★} .$$

The table 1110 shows the associated 2-bit values for the offset vector element

$${( {V}_{i}^{lin} )}^{★} .$$

In the illustrated example, the FP5 element of −6 (11110 in FP binary E2M2) is recast into a linear representation that spans the entire range of FP5 down to the absolute LSB of 0.25. As illustrated, this corresponds to a signed 6-bit value in either fixed-point or integer representation. In both cases the offset is then applied by adding the

$$\frac{{2}^{( {2}^{( {B}_{E} )} + {B}_{μ} - 1 )}}{LSB}$$

value for the given range.

In some embodiments, the system may utilize a PAM4 encoding, which entails 3 iterations of 2-bits each to transmit the full Vᵢ value with the same set of (P_{y})ᵢ, regardless of the chosen linear representation. The silicon photonic receivers (e.g., the RX array 154 or the silicon photonic receiving subsystem 170) detect the modulated optical radiation (e.g., modulated optical signal), the system multiplies each result by its respective 2^{B}^{ₚ}^{y} coefficient and adds them together for the full precision solution. The system determines the actual product Rⱼ by multiplying a vector of the summed matrix rows by the offset and subtracting that value from the result.

FIG. 11B illustrates a table 1120 showing the associated 2-bit values for the vector element

$${V}_{i}^{lin} = - 6$$

after the modified transmitted iterations when a phase shift is available on the silicon photonic device.

As illustrated, with a π-phase shift available on the silicon photonic transmit, no offset to

$${V}_{i}^{lin}$$

is necessary, but we sigh bit is transmitted with each iteration such that the matrix-multiply remains self-consistent through each iteration. The signed 6-bit representation only has 5 bits defining the magnitude, so an extra zero-bit is added to the segment that nominally would have only 1-bit.

In other embodiments, the OVMM system may encode the input vector using cyclic FP iterations. Instead of converting the entire FP range to a linear representation, the system may leverage the linearity of the mantissa at each exponential value to iterate through the full precision of the FP input vector. In such embodiments, an FP input vector may, for example, contain am element Vᵢ with an exponent value of Eᵢ, mantissa of μᵢ, and sign of sᵢ. The system implements the encoding algorithm by stepping through the various exponent values across the FP range with the exponent value for the current step being designated as E_{z}. If E_{z} does not equal Eᵢ, then the system generates an output for Vᵢ=0. However, if E_{z} equals Eᵢ, then Vᵢ begins outputting the mantissa values, μᵢ, as represented below:

$${V}_{i} ( {E}_{Z} ) = \{ \begin{matrix}0 & if & {E}_{Z} \neq {E}_{i} \\ {s}_{i} {μ}_{i} {2}^{{E}_{i}} & if & {E}_{Z} = {E}_{i}\end{matrix}$$

If the precision of the mantissa exceeds the single-cycle precision of the silicon photonic transmit, then the system may iterate through mantissa itself, as follows:

$${V}_{i} = {\sum }_{z = 0}^{{B}_{E} - 1} δ ( {E}_{i} - {E}_{z} ) ( 1 - 2 {s}_{i} ) {2}^{{E}_{i}} {\sum }_{y = 0}^{{B}_{μ} - 1} {( {μ}_{z} )}_{i}$$

The term δ(xᵢ−x_{z}) is the Kronecker delta function. If negative values need to be accounted for within the subnormal ranges, the system applies an offset to raise all values in the range to be greater than zero, as follows:

$$Subnormal offset : ( \frac{{2}^{{B}_{ μ}} - 1}{{2}^{{B}_{μ}}} ) {2}^{- ( {2}^{( {B}_{E} - 1 )} - 2 )}$$

The system transforms the full value of the subnormal vector element, Vᵢ, using the offset, as follows:

$$Subnormal : {( {V}_{i}^{lin} )}^{★} = ( \frac{{2}^{- ( {2}^{( {B}_{E} -- 1 )} - 2 )}}{{2}^{{B}_{μ}}} ) {\underbrace{[ ( {2}^{{B}_{μ}} - 1 ) + ( 1 - 2 {s}_{i} ) {\sum }_{y = 0}^{{B}_{μ} - 1} ( {d}_{y} ) {2}^{( y )}}}_{{( {μ}_{i} )}^{★}}$$

The term (μᵢ)* represents the offset mantissa, the linear binary representation that will be transmitted through the OVMM. As such, the system may digitally calculate this value prior to transmission via the silicon photonic transmitter. After the OVMM is calculated, the system may apply a correction by subtracting to recover the Rⱼ with negative values. This correction can be calculated using a sparse input vector of ones where all the Vᵢ elements share the current exponent. This vector, I, can be defined as:

Iᵢ(E)=δ(Eᵢ−E)

The system can use the vector, I, to define the correction, which is the OVMM of the unitary vector I(E) with the current metasurface state M multiplied by the offset subnormal offset:

$$Subnormal Correction : ( \frac{{2}^{{B}_{ μ}} - 1}{{2}^{{B}_{μ}}} ) {2}^{- ( {2}^{( {B}_{E} - 1 )} - 2 )} {\sum }_{i = 1}^{N} {M}_{ij} {I}_{i}$$

Similarly, for the normal numbers, the system may apply an offset to account for the negative values:

$$Normal offset : ( 1 + \frac{{2}^{{B}_{ μ}} - 1}{{2}^{{B}_{μ}}} ) {2}^{{E}_{i}}$$

$$where {E}_{i} = - ( {2}^{( {B}_{E} - 1 )} - 1 ) + {\sum }_{z = 0}^{{B}_{E} - 1} ( {d}_{z} ) {2}^{( z )}$$

This leads to the normal offset vector element, (Vᵢ)*, being defined as:

$$Normal : {V}_{i} = ( \frac{{2}^{{E}_{i}}}{{2}^{{B}_{μ}}} ) [ {\underbrace{( {2}^{( {B}_{μ} + 1 )} - 1 ) + ( 1 - 2 {s}_{i} ) ( {2}^{{β}_{μ}} + {\sum }_{y = 0}^{{β}_{μ} - 1} ( {d}_{y} ) {2}^{( y )} )}}_{{( {μ}_{i} )}^{★}} ]$$

As before, the system can digitally calculate the value (μᵢ)* prior to transmission as the sum of two integers with precision of (B_{μ}+1). The system may then subtract the correction factor after the OVMM operation for normal FP values is as follows:

$$Normal Correction : ( 1 + \frac{{2}^{{B}_{μ}} - 1}{{2}^{{B}_{μ}}} ) {2}^{{E}_{i}} {\sum }_{i = 1}^{N} {M}_{ij} {I}_{i}$$

Effectively, the system implements a loop within a loop that steps through the exponents and subsequently iterates through the linear mantissa at each exponent. As such, the total number of loops scale as the product of the exponent permutations and the mantissa precision plus the sign-bit as well as the unitary vector I OVMM, expressible as follows:

$$Cyclic FP Iterations = ceil ( \frac{{2}^{{B}_{E}} ( {B}_{μ} + 2 )}{{B}_{p}} )$$

The iteration count represents the maximum number of loops. If no Vᵢ elements exist at a given exponent, Eᵢ, the system skips the exponent. This methodology requires more iterations than the linear representation in almost all cases.

The bit precision of the OVMM is limited by the native precision of the metasurface. The added challenge with extending the precision for FP is again the variance in step-size and the overall nonlinearity of the range. The system, in some embodiments, uses one or more approaches to achieve arbitrary precision. The selected approach may depend on whether the native encoding scheme has a longer or shorter linear range than the desired arbitrary precision FP range. If the mantissa of the desired arbitrary FP range is spanned by the native encoding, it is a much simpler problem than the converse. In some embodiments, the system uses an approach (examples of which are described) that is agnostic to any of the previously detailed native metasurface encoding schemes. As a baseline, the number of iterations any encoding scheme on the metasurface can implement to directly replicate the number of elements in a higher precision is the ratio of the number of elements in each encoding range, expressible as:

$$Iterations = \frac{{2}^{{B}_{A}}}{{2}^{{B}_{M}}}$$

While this can be useful to achieve higher precision, it does not scale well for higher precision, such as in situations in which there is an exact match in the mantissa range. In such an instance, the system may select 7-bit floating-point (FP7) (E4M2) as the desired FP precision, where FP5 (E2M2) is the native encoding.

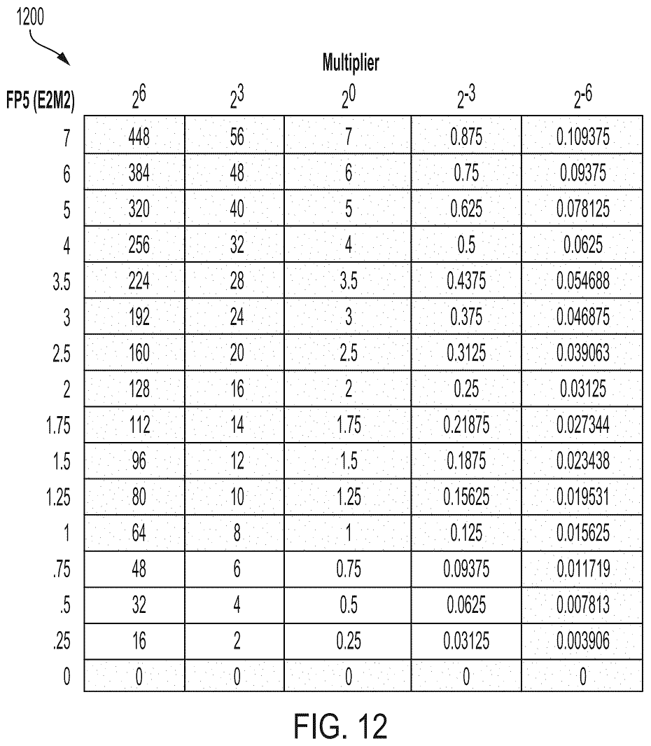

FIG. 12 is a table 1200 illustrating floating-point values in the FP5 (E2M2) format scaled by various powers of two.

As illustrated, the most straightforward methodology would be to scale the FP5 dataset by power of two to perfectly match the range of values for FP7. The values highlighted in green correspond to the utilized values for a given range (only absolute values shown). The subnormal numbers in the FP5 range are underutilized in the higher scaled iterations due not mapping correctly.

As illustrated in the table, it would take 5 iterations to perfectly match the range, but if the desired FP precision is now increased by a single bit to 8-bit floating-point (FP8) (E5M2), the iteration number would double to 10 and continue to balloon with each exponential bit. This scenario is only accounting for a mantissa matched to the native encoding, which is not the case for higher precision FP standards like BF16 and IEEE FP16. Increasing the mantissa precision also leads to the growth of the linear regions of the FP range, which forces a multiplicative increase the iterations based on the ratio of the mantissa precision of the target FP format and the precision of the linear region of the base format. A one-to-one scaled mapping is not the most efficient approach.

As described herein, the system may implement a modulo operator method for encoding to reduce the number of iterations, though with a slight improvement. Again, the general strategy is to translate an FP matrix element, Mᵢⱼ, of precision FP(B_{E}+B_{μ}+1) to a linear representation of precision

$${B}_{A}^{lin} = ( {2}^{( {B}_{E} )} + {B}_{μ} )$$

where the modulo operator can be applied to split Mᵢⱼ into multiple segments using a modulus of Kₖ at each split. In this case, it is convenient to match the precision of the segments to the precision of the encoding scheme for a single cycle of the metasurface, B_{M}. This yields

$$\frac{{B}_{A}^{lin}}{{B}_{M}}$$

segments and a modulus of K_{y}=2^{B}^{_{M}}^{y} at each split.

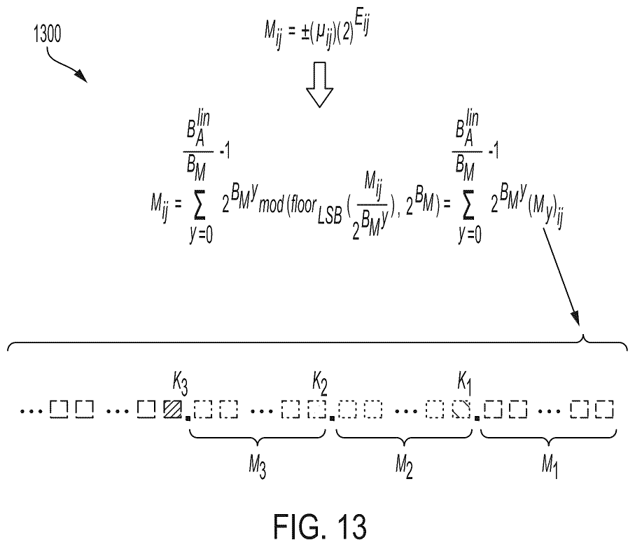

FIG. 13 is a schematic 1300 illustrating a floating-point matrix element decomposed into segments.

The system iterates through each My segment in the OVMM and adds up each result with the appropriate scaling factor to extract the final product solution of R. If a set of segments were examined for a given Mᵢⱼ most of these (Mk) ij would simply be zero. The only nonzero segments would be in the range Eᵢⱼ−B_{μ}<B_{M}y≤Eᵢⱼ. Accordingly, it is not necessary to fully convert Mᵢⱼ to a linear representation. The linear representation is already given by the mantissa, so it is just a matter of scaling it appropriately relative to the K_{y} for the given nonzero M_{y} segment. Otherwise, fully converting would be untenable as a large FP precision such as BF16 would translate to a linear representation of 263-bit (which is why floating-point representation exists in the first place).

Taking into account the iterative formalism for floating-point Vᵢ, the expanded solution for a given product element Rⱼ is as follows:

$${R}_{j} = {\sum }_{i = 1}^{N} {\sum }_{y = 0}^{\frac{{B}_{A}^{lin}}{{B}_{M}} - 1} {2}^{{B}_{M} y} {( {M}_{y} )}_{ij} ( {V}_{i}^{lin} + {2}^{( {2}^{( {B}_{E} )} + {B}_{μ} - 1 )} ) - ( {2}^{( {2}^{( {B}_{E} )} + {B}_{μ} - 1 )} ) {\sum }_{i = 1}^{N} {\sum }_{y = 0}^{\frac{{B}_{A}^{lin}}{{B}_{M}} - 1} {2}^{{B}_{M} y} {( {M}_{y} )}_{ij}$$

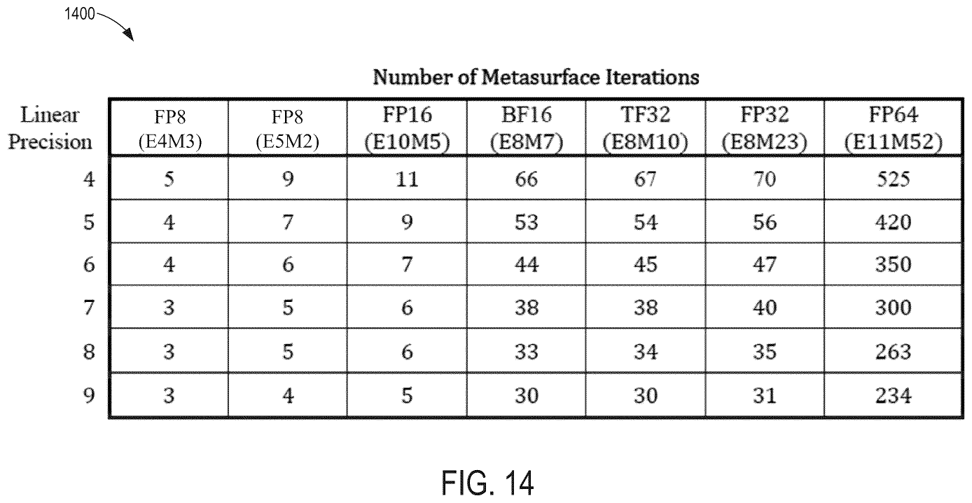

FIG. 14 illustrates a table 1400 of the number of metasurface cycles used to attain various levels of floating-point precision with respect to the linear precision on the metasurface.

The first row of the table 1400 lists precision levels described above with respect to the encoding scheme of the present disclosure. Each subsequent row of the table presents precision results obtained from a corresponding number of metasurface iterations, specifically from 4 to 9 iterations. For example, an FP8 (E4M3) encoding scheme demonstrates an FP precision of 5 when the metasurface is iterated 4 times, compared to an FP precision of 3 when the metasurface is iterated 7 to 9 times. As another example, an FP32 (E8M10) encoding scheme demonstrates an FP precision of 70 when the metasurface is iterated 4 times, compared to an FP precision of 31 when the metasurface is iterated 9 times. As will be appreciated from the tabulated data, the techniques of the present disclosure are not limited to any fixed precision level but rather enables a scalable and tunable precision that may be adjusted by varying the number of metasurface iterations.

FIG. 15A is a metasurface cell 1500 which may be included in the SLM 146 of the OVMM device 130 of FIG. 1B and/or the metasurface 166 of the OVMM system 160 of FIG. 1C. As shown in FIG. 15A, cell 1500 includes a dielectric material 1502 between two resonators 1504. The dielectric material 1502 may comprise a liquid crystal. Examples of the liquid crystal dielectric material 1502 are discussed further in connection with FIG. 16.

In some embodiments, a metasurface cell 1500 may include two or more dielectric layers (not shown) forming a multilayer dielectric stack (e.g., a multilayer liquid crystal stack). The two or more dielectric layers may be adjacent, or may be interleaved between resonators. Two or more programming to drive such a multilayer, e.g., to provide different optical properties at different heights of the metasurface array.

FIG. 15B is a graph 1510 showing liquidus/solidus lines (estimated Tₘᵢₓ) corresponding to Xₐ (solid line; 1512) and X_{b} (dashed line; 1514), according to some embodiments described herein. The Eutectic point 1516 is shown as the intersection (circle). The Eutectic point 1516 is the lowest temperature at which the specific composition of the mixture remains in a liquid phase before solidifying.

Accordingly, the Eutectic point 1516 represents a composition of the binary mixture at which the liquid crystal formulation achieves a minimum melting temperature, which may be used for the development of high-birefringence liquid crystal mixtures. High-birefringence liquid crystal mixtures may be used in a metasurface in optical computing due to the ability to maintain a stable nematic phase over a broad temperature range. The Eutectic composition may ensure that the liquid crystal material remains in a functional phase at lower temperatures than either of its pure components, preventing premature crystallization that could degrade optical performance.

The temperature behavior may be estimated using Van't Hoff's equation (below), which models the melting temperature (Tₘᵢₓ) of a multi-component mixture as a function of the enthalpies of fusion and mole fractions of individual components. In this formulation, the equilibrium melting point is derived under the assumption of ideal mixing, where each component is completely miscible in both the solid and liquid states, and intermediate phase transitions (e.g., smectic, cholesteric, and/or other phases) do not interfere with the Eutectic behavior.

The mixture melting point, Tₘᵢₓ, can be estimated where Xₖ is the mole fraction of the k-component,

$$Δ {H}_{m}^{k}$$

is the melting enthalpy,

$${T}_{m}^{k}$$

is the melting temperature of the pure k-component, and R is the gas constant.

$${lnX}_{k} = - \frac{Δ {H}_{m}^{k}}{R} ( \frac{1}{{T}_{mix}} - \frac{1}{{T}_{m}^{k}} )$$

$${\sum }_{k = 1}^{n} {X}_{k} = 1$$

FIG. 15B shows an estimation of the Eutectic point 1516 for a simple binary mixture of components having

$${T}_{m}^{a} = 83.1 C , {T}_{m}^{b} = 103.2 C ,$$

$$Δ {H}_{m}^{a} = 24 Kj / mol , Δ {H}_{m}^{b} = 30.92 Kj / mol .$$

At temperatures above the liquidus/solidus lines the mixture is entirely liquid. Similarly, at temperatures below the lines, the mixture is entirely solid. The Eutectic point 1516 is estimated as the lowest temperature at which the mixture Xₐ+X_{b}=1 (the intersection of Xₐ and X_{b} lines).

Above the Eutectic temperature, the system remains in a fully liquid state. Below the Eutectic temperature, the components begin to solidify according to their respective phase diagrams, but the Eutectic composition crystallizes as a homogeneous solid. The composition of the liquid crystal mixture may be adjusted in terms of the relative mole fractions of the constituent mesogens to select a target melting point, target birefringence, and/or target viscosity, according to the specific usage application in high-performance optical modulation for optical computing. The same principles extend beyond binary mixtures and may be generalized to multi-component Eutectic systems.

Practical high-birefringence nematic liquid crystal mixtures are typically not composed of only two components. As a generalization, the more components that make up a mixture, the lower it's freezing temperature will be. In the case of mixtures with n components, the Van't Hoff equations may be used to iteratively minimize Tₘᵢₓ and determine the mol fraction of each component at this minimum temperature, which is taken to be the Eutectic point 1516. It is important to note that this analysis gives a useful starting point for preparing a Eutectic mixture, but is not necessarily indicative of exactly the final mixture that yields best results due to deviation from ideal mixture behavior.

Several examples of individual liquid crystal mesogenic molecular structures (LC Singles) from which high-birefringence mixtures (generally accepted as Δnₘᵢₓ>0.3) may be formulated, are given in FIG. 16 (structures 1-6). Although many other physical parameters are useful for the realization of practically useful liquid crystal mixtures, writing in general terms, where

$${\sum }_{k = 1}^{n} {X}_{k} = 1 ,$$

the mole fractions of a mixture having n components the components may be used, along with known values for Δn^{k}, in a simple linear combination to estimate Δnₘᵢₓ using

$${\sum }_{k = 1}^{n} {X}_{k} ( Δ {n}^{k} ( ω ) ) = Δ {n}_{mix} ( ω )$$

In one possible embodiment, the liquid crystal mixture employed herein contains any or all of the above base structures (1-6), where: A equals CH₂, O, N, or S; R₁-R₁₂ equals CₙH₍₂ₙ₊₁₎, H, F, Cl, SCₙH₍₂ₙ₊₁₎, or Br; and J equals NCS, F, CN, CF₃, OCF₃, Br, Cl, or H. In this case R₁-R₁₂, may be the same or different in the same structure, and they may be the same or different among disparate and/or homologous structures. Generally, there will be structures or groups of structures in which R₁-R₁₂ are all H, and also examples in which only one or two R-groups are replaced by F and/or Cl, alkyl, etc.

The common descriptive name for Structure 1 is: cyclohexyl-phenyl. It consists of a cyclohexyl ring and a phenyl ring attached together, and includes all possible combinations of A, J, Cₙ, and R₁-R₈.

The common descriptive name for Structure 2 is: a biphenyl when m=0, a terphenyl when m=1, and a quaterphenyl when m=2, with multiple phenyl rings attached together by intermediate single bonds and includes all possible combinations of A, J, Cₙ, and R₁-R₁₂.

The common descriptive name for Structure 3 is: a tolane. A tolane at its most basic form consists of phenyl rings at either end of a triple bond and includes all possible combinations of A, J, Cₙ, and R₁-R₈.

The common descriptive name for Structure 4 is: a cyclohexyl-tolane. This simply adds a cyclcohexyl ring to either side of the base tolane when m=1, and may be extended to the phenyl tolane structure (5) when m=2 (e.g., cyclohexyl-phenyl tolane) and includes all possible combinations of A, J, Cₙ, and R₁-R₈.

The common descriptive name for Structure 5 is: a phenyl-tolane. A phenyl ring is added to the base tolane structure and includes all possible combinations of A, J, Cₙ, and R₁-R₈.

The common descriptive name for Structure 6 is: a phenyl-bis-tolane. It places triple-bonds between multiple phenyl groups and includes all possible combinations of A, J, Cₙ, and R₁-R₁₂.

Added for descriptive purposes: (not limiting the possible embodiments covered here), the number of carbons in the flexible carbon “tail” attached to A commonly varies between n=1 and n=7: n=1 methyl; n=2 ethyl; n=3 propyl; n=4 butyl, etc. This may vary with groups of structures in order to modify melting point.

In some embodiments, the LC material is configured to provide tunability of one or more electromagnetic properties including refractive indices (ordinary index no, extraordinary index nₑ), birefringence (Delta n=nₑ−nₒ), absorption, dichroism, and/or dielectric properties (e.g., dielectric anisotropy Delta epsilon), in one or more spectral bands. Non-limiting spectral bands include visible, near-infrared (including telecommunications wavelengths such as around 1.3 μm and 1.55 μm), mid-infrared, long-wave infrared, terahertz, millimeter-wave, microwave, and radio-frequency bands.

In some embodiments, high-birefringence LC single compounds (“LC singles”) include mesogenic molecules having an elongate rigid core that provides high electronic polarizability anisotropy. The rigid core may comprise two or more cyclic units selected from a group consisting of: aryl rings (e.g., phenyl), fused aryl systems (e.g., naphthyl), heteroaryl rings (e.g., pyridyl, pyrimidinyl, thiophenyl, thienothiophenyl, benzothiazolyl), and cycloaliphatic rings (e.g., cyclohexyl, bicyclohexyl), and combinations thereof.

The cyclic units of the rigid core may be connected by one or more linking groups selected from a group consisting of: a single bond; ethynyl (C≡C); diacetylene (C≡C—C≡C); vinylene (CH—CH); azo (N≡N); imine (CH═N); ester; ether; thioether; carbonyl-containing linkers; and combinations thereof. In some embodiments, one or more linking groups are configured to increase pi-conjugation length (e.g., ethynyl or diacetylene linkers) to increase birefringence, while other groups are configured to reduce melting point, suppress smectic ordering, or reduce viscosity. In some embodiments, the rigid core optionally includes one or more heteroatoms (e.g., N, O, S, Se) within the ring system and/or within a linker, and optionally includes one or more fused-ring or sulfur-containing motifs (e.g., benzothiophene or dibenzothiophene cores), which may increase polarizability and birefringence.

In some embodiments, LC singles include one or more flexible terminal groups (also referred to as “tails”) and one or more polar end groups. The tails may be independently selected from a group consisting of: C1-C20 alkyl, C2-C20 alkenyl, C2-C20 alkynyl, C1-C20 alkoxy, C1-C20 thioalkyl, and optionally fluorinated analogs thereof (e.g., partially or fully fluorinated alkyl or alkoxy). The tails may be linear, branched, cyclic, or contain one or more heteroatoms. Non-limiting examples of polar end groups include isothiocyanate (NCS), nitrile (CN), thiocyanate (SCN), halogens (F, Cl, Br, I), trifluoromethyl (CF₃), trifluoromethoxy (OCF₃), difluoromethoxy (OCHF₂), sulfonyl-containing groups, and other electron-withdrawing groups capable of providing a permanent dipole moment and/or modifying dielectric anisotropy.

In some embodiments, LC singles include lateral substituents (on one or more rings of the rigid core) selected from a group consisting of: halogens, alkyl, alkoxy, thioalkyl, cyano, trifluoromethyl, and combinations thereof. Lateral substitution patterns may be configured to tune melting point, clearing point, dielectric anisotropy, elastic constants, viscosity, and/or to suppress smectic phases and broaden the nematic range.

The illustrative Structures (1-6) shown in FIG. 16 and their described variants are intended as examples and are not intended to be limiting. In some embodiments, the LC material includes Structures (1-6), derivatives thereof, and/or structurally related mesogens that share one or more of the following: (i) two or more cyclic units; (ii) one or more ethynyl or diacetylene linkers; (iii) one or more polar end groups; and (iv) one or more flexible tails. Accordingly, in one possible embodiment, and without limiting other embodiments, for Structures (1-6): A may be selected from a group consisting of: CH2, O, S, Se, NR (where R is H or an alkyl), carbonyl-containing linkers, and combinations thereof; R1-R12 may be independently selected from a group consisting of: H, halogens, C1-C20 alkyl, C2-C20 alkenyl, C2-C20 alkynyl, C₁-C₂₀ alkoxy, C1-C20 thioalkyl, cyano, trifluoromethyl, and optionally fluorinated analogs thereof; and J may be selected from a group consisting of: NCS, CN, SCN, halogens, CF3, OCF3, and other polar terminal groups. In this context, R₁-R₁₂ may be the same or different within a given structure and may be the same or different among disparate, homologous, and/or isomeric structures. The number of carbon atoms in one or more flexible tails may be, for example, from n=1 to n=20. In some embodiments, one or more of the rings shown in Structures (1-6) may be replaced by a heteroaryl ring or a fused ring system, and/or one or more phenyl rings may be replaced by a cycloaliphatic ring, provided that the resulting molecule exhibits a liquid crystalline phase in at least a portion of the operating temperature range.

In some embodiments, the LC material is formulated as a Eutectic mixture comprising multiple LC singles configured to provide a desired combination of melting point, clearing point, birefringence, dielectric anisotropy, elastic constants, viscosity, resistivity, and stability. In some embodiments, high-birefringence LC singles are blended with one or more low-viscosity components (diluents) such as nonpolar or weakly polar cycloaliphatic mesogens (e.g., bicyclohexyl-based mesogens) to reduce rotational viscosity and/or to improve response time while maintaining a target birefringence.

In some embodiments, mixtures include combinations of different polar end groups (e.g., nitrile-terminated singles combined with isothiocyanate-terminated singles) to tune dielectric anisotropy, suppress aggregation effects, and/or balance viscosity and optical performance.

In some embodiments, one or more hydrogen atoms in any LC single compound may be replaced with deuterium (D) or another isotope to improve photochemical stability, adjust absorption, and/or modify physical properties. In some embodiments, stereoisomers, regioisomers, conformational isomers, and/or tautomers of any LC single compound are included within the scope of the LC material.

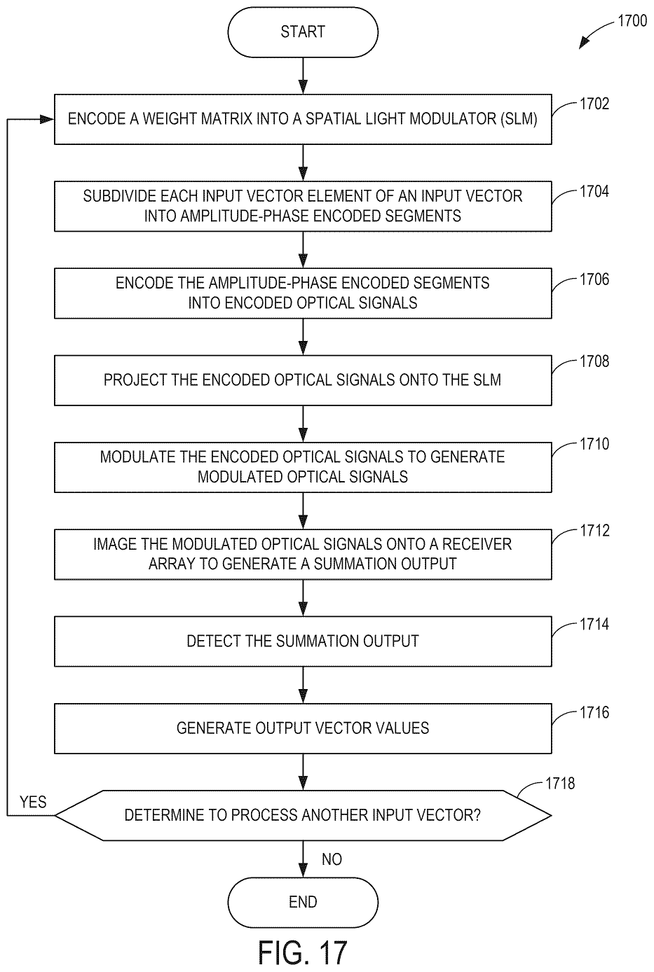

FIG. 17 is a flowchart 1700 representative of an example process that may be performed by the OVMM device 130 of FIG. 1B. Additionally and/or alternatively, the flowchart 1700 may be representative of an example process that may be performed by the OVMM system 160 of FIG. 1C, or portion(s) thereof, such as the OVMM device 162 and/or the free space optical subsystem 168 of FIG. 1C. In some embodiments, at least some of the blocks of the flowchart 1700 may be implemented by processor circuitry executing processor-executable instructions, such as the OVMM device 162 of FIG. 1C executing processor-executable instructions to implement the corresponding functions.

The flowchart 1700 of FIG. 17 begins at block 1702, at which a controller of an optical computing system (e.g., the OVMM system 160) encodes a weight matrix M into an SLM (e.g., the SLM 146 and the metasurface 166). The SLM includes a plurality of pixels, where each pixel of the plurality of pixels corresponds to a portion of the weight matrix M.

In some embodiments, encoding the weight matrix M into the SLM includes encoding an SLM pixel to represent a weight matrix element Mᵢⱼ, wherein the weight matrix element Mᵢⱼ comprises a most significant bit (MSB) and a least significant bit. The MSB may map to real numbers. The LSB may map to imaginary numbers. Matrix elements may be encoded into the SLM using methods, for example, described in connection with the descriptions of FIGS. 2, 7, 8A-8B, 9, and 10A-10C.

In some embodiments, encoding the weight matrix M into the SLM comprises transmitting each weight matrix element Mᵢⱼ of the weight matrix M into iteratively, such that a first matrix element M₁₁ is encoded into a first pixel of the SLM before a second matrix element M₁₂ is encoded into a second pixel of the SLM.

Each pixel of the plurality of pixels is configured in accordance with a complex reflection coefficient. In some embodiments, the complex reflection coefficient is determined by normalizing the upper bit value and the lower bit value encoded in the pixel to a threshold half-precision value and using the threshold half-precision value to determine the complex reflection coefficient of the pixel.

For example, the control circuit 172 (e.g., the controller) encodes a weight matrix into the metasurface 166 of the OVMM device 162, as described in connection with FIG. 1C. As another example, a controller encodes the two-dimensional modulation matrix 114 into an SLM wherein each pixel of the SLM corresponds to a weight matrix element of the two-dimensional modulation matrix 114, as described in connection with FIG. 1A.

In some embodiments, the controller retrieves the weight matrix from a high-bandwidth memory (e.g., the SRAM of the control circuit 172). The controller may store the retrieved weight matrix in the SRAM in an electronic integrated circuit (EIC) (e.g., the control circuit 172), the EIC coupled to the high-bandwidth memory. In some embodiments, the VPU is configured to retrieve the weight matrix from the high-bandwidth memory and store the retrieved weight matrix in the SRAM.

At block 1704, the controller subdivides each input vector element of an input vector into amplitude-phase encoded segments. For example, a controller subdivides (e.g., segments) the vector-encoded optical signal 108 of the optical vector-matrix multiplication system 100, as described in connection with FIG. 1A. The controller may subdivide each input vector elements as described, for example, in connection with the description of FIGS. 3 and/or 13.

At block 1706, a transmitter array encodes the amplitude-phase encoded segments into encoded optical signals. For example, the TX array 134 encodes the amplitude-phase encoded segments into encoded optical signals in the TX elements 136, as described in connection with FIG. 1B. As another example, the silicon photonic transmitter subsystem 164 of the OVMM device 162 encodes the amplitude-phase encoded segments into a transmitter (e.g., transmitter array), as described in connection with FIG. 1C.

In some embodiments the EIC encodes entries of the input vector using a plurality of optical modulators of the transmitter array in accordance with the weight matrix stored in the static random-access memory.

At block 1708, the transmitter array projects the encoded optical signals onto the SLM. The transmitter array may project the encoded optical signals along a first free space optical path. For example, the TX array 134 projects optical signals (e.g., the vector-encoded optical signal 108 and the fanned-out vector-encoded optical signal 110) along the first free space optical path 132A and onto the SLM 146, as described in connection with FIG. 1B. As another example, silicon photonic transmitter subsystem 164 may be configured to iteratively illuminate the SLM with the encoded optical signal carrying the amplitude-phase encoded segments, such that each SLM pixel is configured to execute a pointwise multiplication of a respective amplitude-phase encoded segment of the input vector with a corresponding weight matrix element of the weight matrix.

At block 1710, the SLM modulates the encoded optical signals at the plurality of pixels of the SLM according to corresponding matrix entries of the weight matrix M to generate modulated optical signals. For example, the SLM 146 modulates the fanned-out vector-encoded optical signal 110 using the weight matrix encoded in the SLM 146 to generate the SLM output 147 (e.g., modulated optical signals), as described in connection with FIG. 1B.

At block 1712, the modulated optical signals are imaged onto a receiver array to generate a summation output. The modulated optical signals may be imaged along a second free space optical path. For example, the OVMM device 130 images the fanned-in optical signal 149 along the second free space optical path 132B and onto the RX array 154, as described in connection with FIG. 1B. In other embodiments, the modulated optical signals are imaged onto a receiver.

At block 1714, the receiver array detects the summation output. For example, the RX elements 156 of the RX array 154 detect the fanned-in optical signal 149, as described in connection with FIG. 1B. As another example, the silicon photonic receiving subsystem 170 of the OVMM device 162 detects the summation output using a receiver, as described in connection with FIG. 1C.

At block 1716, output vector values are generated by extracting them from the summation output. In some embodiments, the receiver array extracts the output vector values. For example, the RX array 154 may extract the output vector values from the fanned-in optical signal 149 (e.g., the summation output). In some embodiments, the controller extracts the output vector values from the summation output. For example, the control circuit 172 (e.g., control circuit or controller) may extract output vector values from the summation output. In some embodiments, the summation output comprises a partial product of the VMM. In such embodiments, the control circuit 172 configured to obtain amplitude and phase information indicative of each partial product. The control circuit 172 may be configured to combine partial products detected over multiple cycles of the OVMM to reconstruct the output vector at a target numerical precision.

At block 1718, the OVMM device (e.g., OVMM device 130) may determine whether to encode another input vector. For example, the EIC may transmit drive signals to the modulators of the metasurface 166 with elements of the weight matrix or a different weight matrix. In some embodiments, this reprogramming of the metasurface 166 with the different weight matrix is performed without physically reconfiguring the OVMM system 160 and/or the metasurface 166. For example, the metasurface 166 may be repeatedly encoded by different weight matrices without physical changes to the metasurface 166. As another example, the SLM 146 may be reprogrammed with a different weight matrix to perform a subsequent OVMM cycle.

If, at block 1718, the OVMM device determines to encode another input vector, control returns to block 1702 to begin another optical vector-matrix multiplication cycle. For example, the OVMM system may repeat the method until a target precision of the output vector values meets a target precision threshold. Otherwise, the flowchart 1700 of FIG. 17 concludes.

In some embodiments, the method depicted in flowchart 1700 is configured for multilayer computations, wherein the optical vector-matrix multiplication is performed in a plurality of computation layers. In such embodiments, the method cascades through the plurality of computation layers. For example, the method of flowchart 1700 may be performed in a computation layer of the plurality of computation layers, generating first output vector values. The first output vector values are then fed back into a subsequent computation layer as an input vector to be encoded by the TX array (e.g., transmitter). For each of the plurality of computation layers, the SLM may be reprogrammed with a different weight matrix without physical reconfiguration of the SLM. Such cascading computations may be implemented in multilayered computational architectures, such as deep neural networks (DNN), convolutional neural networks (CNN), and recurrent neural networks (RNN).

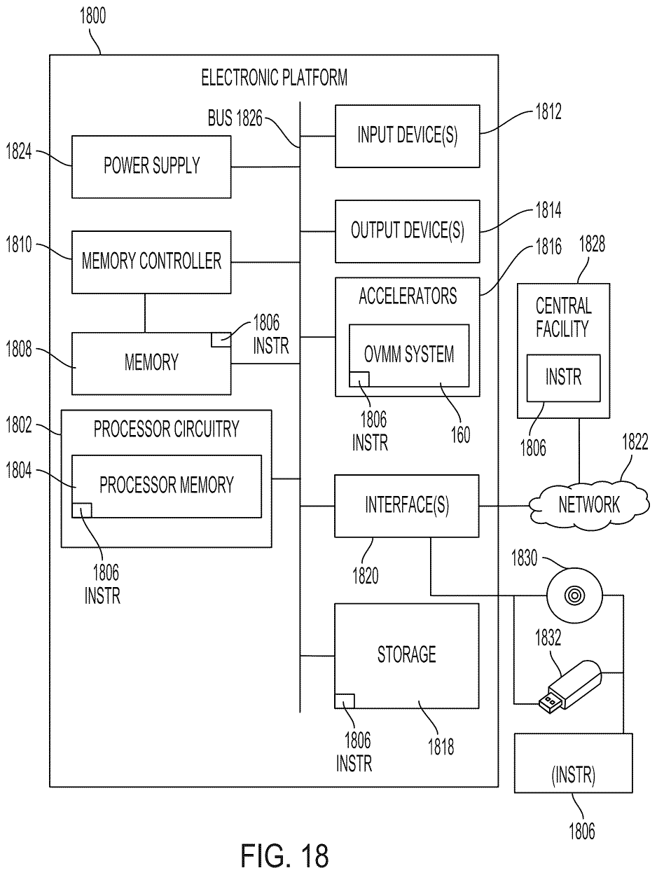

FIG. 18 is an example implementation of an electronic platform 1800 structured to effectuate the process implemented by the flowchart 1700 of FIG. 17 to implement (i) the OVMM system 100 of FIG. 1A, (ii) the OVMM device 130 of FIG. 1B, and/or (iii) the OVMM device 162 of FIG. 1C, and/or, more generally, the OVMM system 160 of FIG. 1C. It should be appreciated that FIG. 18 is intended neither to be a description of necessary components for an electronic and/or computing device to operate as a free space optical architecture, an OVMM device, and/or an OVMM system, in accordance with the techniques described herein, nor a comprehensive depiction.

In some embodiments, the electronic platform 1800 implements an optical computing apparatus at least in part. The electronic platform 1800 of this example may be an electronic device, such as a handset device (e.g., a cellular network device, a smartphone, etc.), a desktop computer, a laptop computer, a tablet computer, a server (e.g., a computer server, a blade server, a rack-mounted server, etc.), a wearable device (e.g., an augmented reality and/or virtual reality (AR/VR) device, a heads-up display (HUD) device, a workstation, or any other type of computing and/or electronic device.

The electronic platform 1800 of the illustrated example includes processor circuitry 1802, which may be implemented by one or more programmable processors, one or more hardware-implemented state machines, one or more ASICs, etc., and/or any combination(s) thereof. For example, the one or more programmable processors may include one or more CPUs, one or more DSPs, one or more FPGAs, one or more GPUs, etc., and/or any combination(s) thereof. The processor circuitry 1802 includes processor memory 1804, which may be volatile memory, such as random-access memory (RAM) of any type.

The processor circuitry 1802 may execute machine-readable instructions 1806 (identified by INSTRUCTIONS), which are stored in the processor memory 1804. Additionally and/or alternatively, the accelerators 1816 may execute the machine-readable instructions 1806 to implement the OVMM device 162 and/or, more generally, the OVMM system 160 of FIG. 1C. In some embodiments, the machine-readable instructions 1806 may be stored in memory of the OVMM system 160, such as the SRAM 178 and/or the HBM module 180 of FIG. 1C.

The machine-readable instructions 1806 may include data representative of computer-executable and/or machine-executable instructions implementing techniques that operate according to the techniques described herein. For example, the machine-readable instructions 1806 may include data (e.g., code, embedded software (e.g., firmware), software, etc.) representative of the flowchart 1700 of FIG. 17, or portion(s) thereof.

The electronic platform 1800 includes memory 1808, which may include the instructions 1806. The memory 1808 of this example may be controlled by a memory controller 1810. For example, the memory controller 1810 may control reads, writes, and/or, more generally, access(es) to the memory 1808 by other component(s) of the electronic platform 1800. The memory 1808 of this example may be implemented by volatile memory, non-volatile memory, etc., and/or any combination(s) thereof. For example, the volatile memory may include HBM, SRAM, dynamic random-access memory (DRAM), cache memory (e.g., Level 1 (L1) cache memory, Level 2 (L2) cache memory, Level 3 (L3) cache memory, etc.), etc., and/or any combination(s) thereof. In some examples, the non-volatile memory may include Flash memory, electrically erasable programmable read-only memory (EEPROM), magnetoresistive random-access memory (MRAM), ferroelectric random-access memory (FeRAM, F-RAM, or FRAM), etc., and/or any combination(s) thereof.

The electronic platform 1800 includes input device(s) 1812 to enable data and/or commands to be entered into the processor circuitry 1802. For example, the input device(s) 1812 may include an audio sensor, a camera (e.g., a still camera, a video camera, etc.), a keyboard, a microphone, a mouse, a touchscreen, a voice recognition system, etc., and/or any combination(s) thereof.

The electronic platform 1800 includes output device(s) 1814 to convey, display, and/or present information to a user (e.g., a human user, a machine user, etc.). For example, the output device(s) 1814 may include one or more display devices, speakers, etc. The one or more display devices may include an augmented reality (AR) and/or virtual reality (VR) display, a liquid crystal display (LCD), a light-emitting diode (LED) display, an organic light-emitting diode (OLED) display, a quantum dot (QLED) display, a thin-film transistor (TFT) LCD, a touchscreen, etc., and/or any combination(s) thereof. The output device(s) 1814 can be used, among other things, to generate, launch, and/or present a user interface. For example, the user interface may be generated and/or implemented by the output device(s) 1814 for visual presentation of output and speakers or other sound generating devices for audible presentation of output.

The electronic platform 1800 includes accelerators 1816, which are hardware devices to which the processor circuitry 1802 may offload compute tasks to accelerate their processing. For example, the accelerators 1816 may include artificial intelligence/machine-learning (AI/ML) processors, ASICs, FPGAs, graphics processing units (GPUs), neural network (NN) processors, systems-on-chip (SoCs), vision processing units (VPUs), etc., and/or any combination(s) thereof. In this example, the accelerators 1816 implement the OVMM system 160 of FIG. 1C. Although only one OVMM system 160 is shown, the accelerators 1816 may implement any number of the OVMM system 160.

The electronic platform 1800 includes storage 1818 to record and/or control access to data, such as the machine-readable instructions 1806. The storage 1818 may be implemented by one or more mass storage disks or devices, such as HDDs, SSDs, etc., and/or any combination(s) thereof.

The electronic platform 1800 includes interface(s) 1820 to effectuate exchange of data with external devices (e.g., computing and/or electronic devices of any kind) via a network 1822. The interface(s) 1820 of the illustrated example may be implemented by an interface device, such as network interface circuitry (e.g., a NIC, a smart NIC, etc.), a gateway, a router, a switch, etc., and/or any combination(s) thereof. The interface(s) 1820 may implement any type of communication interface, such as BLUETOOTH®, a cellular telephone system (e.g., a 4G LTE interface, a 5G interface, a future generation 6G interface, etc.), an Ethernet interface, a near-field communication (NFC) interface, an optical disc interface (e.g., a Blu-ray disc drive, a Compact Disk (CD) drive, a Digital Versatile Disk (DVD) drive, etc.), an optical fiber interface, a satellite interface (e.g., a BLOS satellite interface, a LOS satellite interface, etc.), a Universal Serial Bus (USB) interface (e.g., USB Type-A, USB Type-B, USB TYPE-C™ or USB-C™ etc.), etc., and/or any combination(s) thereof.

The electronic platform 1800 includes a power supply 1824 to store energy and provide power to components of the electronic platform 1800. The power supply 1824 may be implemented by a power converter, such as an alternating current-to-direct-current (AC/DC) power converter, a direct current-to-direct current (DC/DC) power converter, etc., and/or any combination(s) thereof. For example, the power supply 1824 may be powered by an external power source, such as an alternating current (AC) power source (e.g., an electrical grid), a direct current (DC) power source (e.g., a battery, a battery backup system, etc.), etc., and the power supply 1824 may convert the AC input or the DC input into a suitable voltage for use by the electronic platform 1800. In some examples, the power supply 1824 may be a limited duration power source, such as a battery (e.g., a rechargeable battery such as a lithium-ion battery).

Component(s) of the electronic platform 1800 may be in communication with one(s) of each other via a bus 1826. For example, the bus 1826 may be any type of computing and/or electrical bus, such as an I2C bus, a PCI bus, a PCIe bus, a SPI bus, a UCIe bus, and/or the like.

The network 1822 may be implemented by any wired and/or wireless network(s) such as one or more cellular networks (e.g., 4G LTE cellular networks, 5G cellular networks, future generation 6G cellular networks, etc.), one or more data buses, one or more local area networks (LANs), one or more optical fiber networks, one or more private networks, one or more public networks, one or more wireless local area networks (WLANs), etc., and/or any combination(s) thereof. For example, the network 1822 may be the Internet, but any other type of private and/or public network is contemplated.

The network 1822 of the illustrated example facilitates communication between the interface(s) 1820 and a central facility 1828. The central facility 1828 in this example may be an entity associated with one or more servers, such as one or more physical hardware servers and/or virtualizations of the one or more physical hardware servers. For example, the central facility 1828 may be implemented by a public cloud provider, a private cloud provider, etc., and/or any combination(s) thereof. In this example, the central facility 1828 may compile, generate, update, etc., the machine-readable instructions 1806 and store the machine-readable instructions 1806 for access (e.g., download) via the network 1822. For example, the electronic platform 1800 may transmit a request, via the interface(s) 1820, to the central facility 1828 for the machine-readable instructions 1806 and receive the machine-readable instructions 1806 from the central facility 1828 via the network 1822 in response to the request.

Additionally or alternatively, the interface(s) 1820 may receive the machine-readable instructions 1806 via non-transitory machine-readable storage media, such as an optical disc 1830 (e.g., a Blu-ray disc, a CD, a DVD, etc.) or any other type of removable non-transitory machine-readable storage media such as a USB drive 1832. For example, the optical disc 1830 and/or the USB drive 1832 may store the machine-readable instructions 1806 thereon and provide the machine-readable instructions 1806 to the electronic platform 1800 via the interface(s) 1820.

Techniques operating according to the principles described herein may be implemented in any suitable manner. The processing and decision blocks of the flowchart(s) above represent steps and acts that may be included in algorithms that carry out these various processes. Algorithms derived from these process(es) may be implemented as software integrated with and directing the operation of one or more single- or multi-purpose processors, may be implemented as functionally equivalent circuits such as a DSP circuit or an ASIC, or may be implemented in any other suitable manner. It should be appreciated that the flowchart(s) included herein do(es) not depict the syntax or operation of any particular circuit or of any particular programming language or type of programming language. Rather, the flowchart(s) illustrate the functional information one skilled in the art may use to fabricate circuits or to implement computer software algorithms to perform the processing of a particular apparatus carrying out the types of techniques described herein. For example, the flowchart(s), or portion(s) thereof, may be implemented by hardware alone (e.g., one or more analog or digital circuits, one or more hardware-implemented state machines, etc., and/or any combination(s) thereof) that is configured or structured to carry out the various processes of the flowcharts. In another example, the flowchart(s), or portion(s) thereof, may be implemented by machine-executable instructions (e.g., machine-readable instructions, computer-readable instructions, computer-executable instructions, etc.) that, when executed by one or more single- or multi-purpose processors, carry out the various process(es) of the flowchart(s). It should also be appreciated that, unless otherwise indicated herein, the particular sequence of steps and/or acts described in each flowchart is merely illustrative of the algorithms that may be implemented and can be varied in implementations and embodiments of the principles described herein. Accordingly, in some embodiments, the techniques described herein may be embodied in machine-executable instructions implemented as software, including as application software, system software, firmware, middleware, embedded code, or any other suitable type of computer code. Such machine-executable instructions may be generated, written, etc., using any of a number of suitable programming languages and/or programming or scripting tools, and also may be compiled as executable machine language code or intermediate code that is executed on a framework, virtual machine, or container.

In some, but not all, implementations in which the techniques may be embodied as machine-executable instructions, these instructions may be executed on one or more suitable computing device(s) and/or electronic device(s) operating in any suitable computer and/or electronic system, or one or more computing devices (or one or more processors of one or more computing devices) and/or one or more electronic devices (or one or more processors of one or more electronic devices) may be programmed to execute the machine-executable instructions. A computing device, electronic device, or processor (e.g., processor circuitry) may be programmed to execute instructions when the instructions are stored in a manner accessible to the computing device, electronic device, or processor, such as in a data store (e.g., an on-chip cache or instruction register, a computer-readable storage medium and/or a machine-readable storage medium accessible via a bus, a computer-readable storage medium and/or a machine-readable storage medium accessible via one or more networks and accessible by the device/processor, etc.).

Machine-executable instructions (e.g., processor-executable instructions) implementing the techniques described herein may, in some embodiments, be encoded on one or more computer-readable media, machine-readable media, etc., to provide functionality to the media. Computer-readable media, machine-readable media, etc., include magnetic media such as a hard disk drive, optical media such as a CD or a DVD, a persistent or non-persistent solid-state memory (e.g., Flash memory, Magnetic RAM, etc.), or any other suitable storage media. Such a computer-readable medium, a machine-readable medium, etc., may be implemented in any suitable manner.

Embodiments have been described where the techniques are implemented in circuitry and/or machine-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

As used herein, the terms “computer-readable media” (also called “computer-readable storage media”), “computer-readable medium” (also called “computer-readable storage medium”), “machine-readable media” (also called “machine-readable storage media”), and “machine-readable medium” (also called “machine-readable storage medium”) refer to tangible storage media. Tangible storage media are non-transitory and have at least one physical, structural component. In a “computer-readable medium” and “machine-readable medium” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium, a machine-readable medium, etc., may be altered during a recording process.

Further, some techniques described above comprise acts of storing information (e.g., data and/or instructions) in certain ways for use by these techniques. In some implementations of these techniques—such as implementations where the techniques are implemented as machine-executable instructions—the information may be encoded on a computer-readable storage medium, a machine-readable storage medium, etc. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Accordingly, having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

What is claimed is:

1. A system for performing an optical vector-matrix multiplication (OVMM), the system comprising:
a control circuit configured to:
segment each input vector element of an input vector into amplitude-phase encoded segments;
encode a weight matrix M into a spatial light modulator (SLM), the SLM comprising a plurality of programmable pixels, wherein:
each pixel of the plurality of programmable pixels corresponds to a weight matrix element Mᵢⱼ,
the weight matrix element Mᵢⱼ comprises a most significant bit (MSB) and a least significant bit (LSB); and
each pixel of the plurality of programmable pixels is configured in accordance with a complex reflection coefficient;
a transmitter subsystem configured to:
encode the amplitude-phase encoded segments into encoded optical signals; and
transmit the encoded optical signals to the SLM;
the SLM, wherein the SLM is configured to modulate the encoded optical signals in accordance with matrix entries of the weight matrix M to generate modulated optical signals, the modulated optical signals comprising a plurality of optical signals that is output from the pixels; and
a receiving subsystem configured to collect the modulated optical signals to generate a summation output, wherein the summation output represents a partial product of the vector-matrix multiplication (VMM),
wherein the control circuit is further configured to generate output vector values by extracting them from the summation output.

2. The system of claim 1, wherein the SLM comprises a programmable metasurface, the programmable metasurface comprising a plurality of metasurface cells, each metasurface cell configured to be selectively programmable to modulate amplitude and/or phase of incident light according to the amplitude-phase encoded segments.

3-6. (canceled)

7. The system of claim 1, wherein the transmitter subsystem is configured to iteratively illuminate the SLM with the encoded optical signal carrying the amplitude-phase encoded segments, such that each SLM pixel is configured to execute a pointwise multiplication of a respective amplitude-phase encoded segment of the input vector with a corresponding weight matrix element Mᵢⱼ of the weight matrix M.

8. (canceled)

9. The system of claim 1, wherein:
the summation output comprises a partial product of the VMM; and
the control circuit is configured to obtain amplitude and phase information indicative of each partial product.

10. The system of claim 9, wherein the control circuit is configured to combine partial products detected over multiple cycles of the OVMM to reconstruct the output vector at a target numerical precision.

11. The system of claim 1, wherein each of the plurality of programmable pixels is configured to modulate at least one of an amplitude or a phase of incident light.

12. The system of claim 1, wherein the receiving subsystem is configured detect an in-phase component and/or quadrature component of each of the MSB and LSB simultaneously.

13. (canceled)

14. A method of performing an optical vector-matrix multiplication (OVMM) in an optical computing system, the method comprising:
encoding, by using a controller, a weight matrix M into a spatial light modulator (SLM), the SLM comprising a plurality of pixels, wherein:
each pixel of the plurality of pixels corresponds to a weight matrix element Mᵢⱼ,
the weight matrix element Mᵢⱼ comprises a most significant bit (MSB) and a least significant bit (LSB); and
each pixel of the plurality of pixels is configured in accordance with a complex reflection coefficient;
subdividing, by using the controller, each input vector element of an input vector into amplitude-phase encoded segments;
encoding, by using a transmitter array, the amplitude-phase encoded segments into encoded optical signals;
projecting, by using the transmitter array and a first free space optical path, the encoded optical signals onto the SLM;
modulating, by using the SLM, the encoded optical signals at the plurality of pixels of the SLM according to corresponding matrix entries of the weight matrix M to generate modulated optical signals;
imaging, by using a second free space optical path, the modulated optical signals onto a receiver array to generate a summation output;
detecting, by using the receiver array, the summation output; and
generating output vector values by extracting them from the summation output.

15. The method of claim 14, wherein generating the output vector values comprises using the receiver array to extract the output vector values from the summation output.

16. The method of claim 14, wherein generating the output vector values comprises using the controller to extract the output vector values from the summation output.

17. The method of claim 14, further comprising repeating the OVMM until a target precision of the output vector values meets a target precision threshold.

18. The method of claim 14, wherein generating the output vector values comprises:
determining the complex reflection coefficient for a pixel of the plurality of pixels of the SLM, the determining comprising:
normalizing the MSB and the LSB encoded in the pixel to a threshold half-precision value; and
using the threshold half-precision value to determine the complex reflection coefficient of the pixel,
wherein the threshold half-precision value is 2^{B}^{_{M}}^{/2-1}.

19. The method of claim 14, wherein encoding the weight matrix M into the SLM comprises transmitting each weight matrix element Mᵢⱼ of the weight matrix M into iteratively, such that a first matrix element M₁₁ is encoded into a first pixel of the SLM before a second matrix element M₁₂ is encoded into a second pixel of the SLM.

20-23. (canceled)

24. The method of claim 14, wherein extracting the output vector values from the summation output comprises:
converting the summation output into a linear representation to generate the output vector values,
wherein the input vector is encoded in an FP representation.

25-26. (canceled)

27. The method of claim 14, wherein the method is performed sequentially, the method further comprising:
reprogramming, without physical reconfiguration, the SLM with a different weight matrix to perform a subsequent OVMM cycle.

28. (canceled)

29. The method of claim 14, wherein the transmitter array comprises a plurality of modulators, the method further comprising:
driving, by using the controller, the plurality of modulators; and
decoding, by using the controller, the output vector values from the receiver array.

30-31. (canceled)

32. The method of claim 14, wherein encoding the weight matrix element Mᵢⱼ with the MSB and LSB comprises mapping the MSB to a real axis and mapping the LSB to an imaginary axis.

33. The method of claim 14, wherein generating the output vector values by extracting them from the summation output comprises extracting the output vector values using a first scaling factor and/or a second scaling factor,
wherein the first scaling factor is 2^{B}^{ₚ}^{·y} and the second scaling factor is 2^{B}^{_{M}}^{/2}.

34. The method of claim 14, wherein generating the output vector values by extracting them from the summation output comprises extracting the output vector values using a scaling coefficient 2^{B}^{ₚ}^{·y},
wherein the input vector elements of an input vector were encoded with the scaling coefficient.

35. An optical computing apparatus comprising:
a photonic integrated circuit comprising a plurality of waveguides and modulators configured to encode an input vector, the photonic integrated circuit configured to:
encode a weight matrix M into a spatial light modulator (SLM), the SLM comprising a plurality of programmable pixels, wherein:
each pixel of the plurality of programmable pixels corresponds to a weight matrix element Mᵢⱼ,
the weight matrix element Mᵢⱼ comprises a most significant bit (MSB) and a least significant bit (LSB); and
each pixel of the plurality of programmable pixels is configured in accordance with a complex reflection coefficient;
segment each input vector element of an input vector into amplitude-phase encoded segments;
encode the amplitude-phase encoded segments into encoded optical signals;
project the encoded optical signals onto the SLM
the SLM configured to modulate the encoded optical signals at the plurality of pixels of the SLM according to corresponding matrix entries of the weight matrix M to generate modulated optical signals;
free space optics configured to perform a summation of modulated optical signals to generate a summation output;
a receiver array comprising a plurality of optical detectors configured to detect the summation output; and
an electronic integrated circuit configured to:
drive the modulators on the photonic integrated circuit and to decode output values from the receiver array; and
generate output vector values by extracting them from the summation output.

36. The optical computing apparatus of claim 35, wherein:
the photonic integrated circuit comprises a transmitter array and the receiver array, wherein the transmitter array and the receiver array are arranged in a coplanar co-localization configuration; and
the SLM is positioned in a free space optical path between the transmitter array and the receiver array.

37. (canceled)

38. The optical computing apparatus of claim 35, wherein the photonic integrated circuit is configured to encode the weight matrix M into the SLM by:
encoding an SLM pixel to represent a weight matrix element Mᵢⱼ of the weight matrix M along a first axis; and
projecting the SLM pixel along a first direction such that the weight matrix element Mᵢⱼ=Aᵢⱼ cos θᵢⱼ,
wherein θᵢⱼ is an angle relative to the first axis and Aᵢⱼ is a magnitude of the complex reflection coefficient.

39. The optical computing apparatus of claim 35, wherein the photonic integrated circuit is configured to encode the weight matrix M into the SLM by:
encoding an SLM pixel to represent the weight matrix element Mᵢⱼ of the weight matrix M along a first axis by encoding a floating point (FP) value into the weight matrix element Mᵢⱼ; and
projecting the SLM pixel such that the weight matrix element
$${M}_{ij} = \frac{{M}_{ij}}{{FP}_{max}} + i \frac{mod ( {M}_{ij} , K )}{K} ,$$
wherein K is a modulus, i=\sqrt{−1}, and
mod(Mᵢⱼ,K) is a remainder of a modulo of Mᵢⱼ with respect to K, such that i and j are indices.

40. The optical computing apparatus of claim 35, wherein the photonic integrated circuit is configured to encode the weight matrix M into the SLM by:
encoding an SLM pixel to represent the weight matrix element Mᵢⱼ of the weight matrix M along a first axis by encoding the weight matrix element Mᵢⱼ as a FP value;
splitting a range of the FP value between a first axis and a second axis, wherein the first axis and the second axis are orthogonal; and
projecting the SLM pixel such that the weight matrix element
$${M}_{ij} ⇒ \{ \begin{matrix}{M}_{ij} / {FP}_{max} & if {M}_{ij} > K \\ {M}_{ij} / K & if {M}_{ij} \leq K\end{matrix} ,$$
wherein K is a threshold value and FPₘₐₓ is a threshold FP value for the weight matrix element Mᵢⱼ.

41. The optical computing apparatus of claim 35, wherein the photonic integrated circuit is configured to encode the weight matrix M into the SLM by:
encoding an SLM pixel to represent the weight matrix element Mᵢⱼ of the weight matrix M along a first axis;
encoding an FP value for the weight matrix element Mᵢⱼ; and
projecting the SLM pixel such that the weight matrix element Mᵢⱼ=G_{M}×K+mod(Mᵢⱼ,K),
wherein K is a modulus, mod(Mᵢⱼ,K) is a remainder of a modulo of Mᵢⱼ with respect to K, and G is a largest number from an FP range for the weight matrix element Mᵢⱼ,
wherein the weight matrix element Mᵢⱼ≥G×K.

42. The optical computing apparatus of claim 35, wherein each of the plurality of programmable pixels is configured to modulate at least one of an amplitude or a phase of incident light.

43. (canceled)

44. The optical computing apparatus of claim 35, wherein the electronic integrated circuit comprises processor circuitry configured to drive the modulators on the photonic integrated circuit and to decode output values from the receiver array.

45. The optical computing apparatus of claim 35, wherein the electronic integrated circuit comprises a vision processing unit configured to execute at least one post-detection operation on the output values from the receiver array.

46. (canceled)

47. The optical computing apparatus of claim 35, further comprising high-bandwidth memory configured to store a weight matrix, and wherein the electronic integrated circuit comprises:
static random-access memory; and
a vision processing unit configured to:
retrieve the weight matrix from the high-bandwidth memory and store the retrieved weight matrix in the static random-access memory; and
configure the plurality of optical modulators in accordance with at least a portion of the weight matrix to encode the input vector.

48-52. (canceled)
